(19) United States
(12) Patent Application Publication
(10) Pub. No.: US 2007/0096743 A1
(43) Pub. Date: May 3, 2007

(54) Method and apparatus for judging deterioration of battery

(75) Inventors: Youichi Arai, Shizuoka (JP); Tsutomu Saigo, Shizuoka (JP); Shuji Satake, Shizuoka (JP); Hisashi Takemoto, Shizuoka (JP); Ken Ito, Shizuoka (JP); Yoshiya Miyazaki, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 10/561,792

(22) PCT Filed: Jun. 15, 2004
(86) PCT No.: PCT/JP04/08688

§ 371 Date: Dec. 21, 2005

(30) Foreign Application Priority Data
Jun. 23, 2003 (JP) 2003-178319

(51) Int. Cl. G01N 27/416

(52) U.S. Cl. 324/426

(57) ABSTRACT

A method and apparatus for judging deterioration of a battery are provided, thereby a correct judgement for the deterioration of the battery can be timely carried out so as to replace the battery with another if it is necessary. The apparatus for judging deterioration of a battery that supplies electric power to a load includes: storing means 23c for storing a minimum guaranteed voltage predetermined as a minimum value of a terminal voltage of the battery 13 when a given current flows into the load; voltage drop computing means 23a for computing a voltage drop due to an ohmic resistance and polarization resistance of the battery occurred in response to a discharge of the battery when a given current flows from the battery into the load; first comparing means 23a for comparing the minimum guaranteed voltage stored in the storing means 23c with a first difference value, which is obtained by subtracting the voltage drop computed by the voltage drop computing means 23a from an open circuit voltage that corresponds to a state of charge upon a start of the discharge of the battery; and first deterioration judging means 23a for judging that the battery is deteriorated if the first difference value becomes equal to or smaller than the minimum guaranteed voltage and the state of charge upon the start of the discharge exceeds a first specific value as a result of the comparison by the first comparing means 23a.

### TECHNICAL FIELD

The present invention relates to a method and apparatus for judging deterioration of a battery that supplies electric power to loads.

### BACKGROUND ART

Since an on-vehicle battery is widely used as a power source for starting an engine and operating on-vehicle electronic instruments, therefore it is very important to recognize accurately the state of charge of the on-vehicle battery.

However, in general, an internal impedance of a battery increases as the battery is subjected to repeated charge and discharge processes, therefore its dischargeable capacity from its fully charged state gradually deteriorates.

Consequently, if the state of charge of the battery is desirable to be accurately recognized, the most important point is to know a capacity that can be actually supplied. That is, it is necessary to accurately recognize a present capacity upon a fully charged state of the battery. Hereinafter, the capacity upon a fully charged state is called the fully charged capacity. Accordingly, it has been considered important to find out how to recognize the latest deterioration state (i.e. degree of deterioration) of the battery, which directly affects the fully charged capacity of the battery.

In a general method of judging the deterioration of a battery that supplies electric power to loads, normal values of internal resistance of the battery is prepared as a data table and the deterioration of the battery is judged by comparing measured values of the internal resistance with the normal values of the internal resistance in the data table.

However, the internal resistance of the battery includes ohmic resistance, activation polarization resistance and concentration polarization resistance, in which in particular since the polarization resistance varies in many ways depending on a history of charge and discharge, magnitude of current used upon measurement of the internal resistance, and conducting period of time, that is, there are many factors besides the deterioration, therefore it is not possible to accurately judge the degree of deterioration of the battery.

Further, in another method of recognizing the degree of deterioration of the battery, a value of the fully charged capacity of a battery when it is new is recognized in advance, then this value is compared with a present value of the fully charged capacity of the battery. In this case, conventionally, an amount of discharged current is computed by multiplying a value of discharge current by a discharge period of time while the battery is subjected to a full discharge starting from its fully charged state, then thus computed amount of discharged current is set to be a value of the present fully charged capacity of the battery.

As for an on-vehicle battery, which is mounted on a vehicle having a normal engine as the only drive source or a hybrid vehicle in which power of a motor generator is used as auxiliary means, the motor generator functioning as a motor when output torque of the engine is insufficient, a large amount of the capacity of the on-vehicle battery is consumed mainly upon a start of the engine, however, afterward, the on-vehicle battery is charged to its fully charged state during travelling of the vehicle with electric power generated by an alternator or a motor generator that functions as a generator.

Therefore, when a present value of the fully charged capacity of the battery is needed to be measured for these vehicles described above, an impractical work, in which the battery is removed from the vehicle so that the battery is subjected to a complete discharge starting from its fully charged state, is needed to be carried out. However, of course such an impractical work never can be employed.

Consequently, in order to recognize the latest deterioration state (i.e. degree of deterioration) of the battery, it is very important that a factor varying in response to the deterioration of the battery is found from factors computable by using values measurable on a condition that the battery is mounted on the vehicle, then how a value of the found factor varies starting from its initial value obtained when the battery undergoes no deterioration yet is monitored, thereby realizing the deterioration state (i.e. degree of deterioration) of the battery on the condition that the battery is mounted on the vehicle.

In this connection, the factor that varies in response to the deterioration of the battery is an internal impedance (i.e. combined resistance) of the battery, which causes a voltage drop in a terminal voltage of the battery. The voltage drop can be divided into an IR loss (a voltage drop due to a pure resistance, i.e. ohmic resistance) caused by a structure of the battery and a voltage drop due to a polarization resistance component (activation polarization and concentration polarization) caused by chemical reactions.

Therefore, how the values of the pure resistance, activation polarization and concentration polarization, which are primary factors for the voltage drop in the terminal voltage of the battery, vary starting from their respective initial values obtained when the battery undergoes no deterioration yet are monitored, thereby the latest deterioration state (degree of deterioration) of the battery can be recognized.

However, as for actual deterioration of the battery, there seem to be various modes of deterioration such as the deterioration in which pure resistance increases and the deterioration in which activation polarization and concentration polarization increase. Therefore, there might be a problem that the actual deterioration of the battery is mistakenly recognized by monitoring only one resistance component (for example, pure resistance only). That is, for example, when only pure resistance is monitored, there might be a case, in which a change in the resistance value in comparison with the initial value upon no deterioration of the battery is not very large when the state of charge (i.e. SOC) is equal to or more than 40%, on the other hand, the resistance value rapidly increases when the state of charge becomes less than 40%. Furthermore, as for the activation polarization or concentration polarization, even when the state of charge is equal to or more than 40%, there might be a phenomenon that the resistance value varies to become higher than the initial value upon no deterioration of the battery.

Since there seems to be no regularity in a change in pure resistance, activation polarization or concentration polarization in response to the deterioration of the battery and moreover, there seems to be some cooperative relation between the respective resistance, therefore an accurate judgement regarding the deterioration state of the battery can not be obtained when only one of the pure resistance, activation polarization and concentration polarization is selected and monitored so as to judge the deterioration state of the battery on the basis of an observed change in a value of the resistance selected and monitored.

### DISCLOSURE OF INVENTION

Therefore, the objective of the present invention is to solve the above-mentioned problems and to provide a method and apparatus for judging deterioration of a battery, by which a correct judgement for the deterioration of the battery can be timely carried out so as to replace the battery with another if it is necessary.

In order to solve the above-mentioned problems, the present invention defined in claim 1 is a method of judging deterioration of a battery that supplies electric power to a load comprising the steps of:

comparing a minimum guaranteed voltage predetermined as a minimum value of a terminal voltage of the battery When a given current flows into the load, with a first difference value, which is obtained by subtracting a voltage drop due to an ohmic resistance and polarization resistance of the battery occurred during a discharge of the battery from an open circuit voltage that corresponds to a state of charge (i.e. SOC) upon a start of the discharge of the battery in response to the discharge of the battery with the given current; and

judging the deterioration of the battery on the basis of a result of the comparison.

According to the present invention defined in claim 1, the method of judging deterioration of a battery that supplies electric power to a load comprises the steps of:

comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging the deterioration of the battery on the basis of a result of the comparison, therefore, the deterioration state of the battery can be appropriately judged with respect to the predetermined minimum guaranteed voltage.

In order to solve the above-mentioned problems, the present invention defined in claim 2 is a method of judging deterioration of a battery that supplies electric power to a load comprising the steps of:

comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging that the battery is deteriorated if the first difference value becomes equal to or smaller than the minimum guaranteed voltage and the state of charge upon the start of the discharge exceeds a first specific value.

According to the present invention defined in claim 2, the method of judging deterioration of a battery that supplies electric power to a load comprises the steps of:

comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging that the battery is deteriorated if the first difference value becomes equal to or smaller than the minimum guaranteed voltage and the state of charge upon the start of the discharge exceeds a first specific value,

therefore, the deterioration of the battery can be timely judged with respect to the predetermined minimum guaranteed voltage.

In order to solve the above-mentioned problems, the present invention defined in claim 3 is a method of judging deterioration of a battery that supplies electric power to a load comprising the steps of:

comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

if the first difference value becomes equal to or smaller than the minimum guaranteed voltage and the state of charge upon the start of the discharge is equal to or smaller than a first specific value, converting the state of charge that is equal to or smaller than the first specific value into a state of charge of the first specific value;

comparing the minimum guaranteed voltage with a second difference value, which is obtained by subtracting the voltage drop from an open circuit voltage that corresponds to the converted state of charge of the first specific value; and

judging that the battery is deteriorated if the second difference value is equal to or smaller than the minimum guaranteed voltage.

According to the present invention defined in claim 3, the method of judging deterioration of a battery that supplies electric power to a load comprises the steps of:

comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

if the first difference value becomes equal to or smaller than the minimum guaranteed voltage and the state of charge upon the start of the discharge is equal to or smaller than a first specific value, converting the state of charge that is equal to or smaller than the first specific value into a state of charge of the first specific value;

comparing the minimum guaranteed voltage with a second difference value, which is obtained by subtracting the voltage drop from an open circuit voltage that corresponds to the converted state of charge of the first specific value; and

judging that the battery is deteriorated if the second difference value is equal to or smaller than the minimum guaranteed voltage,

therefore the deterioration of the battery can be accurately judged with respect to the predetermined minimum guaranteed voltage even in a low state of charge, in which a terminal voltage might be lower than the minimum guaranteed voltage even for a normal battery.

In order to solve the above-mentioned problems, the present invention defined in claim 4 is a method of judging deterioration of a battery that supplies electric power to a load comprising the steps of:

comparing a minimum guaranteed dischargeable capacity (dischargeable capacity; ADC) predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging the deterioration of the battery on the basis of a result of the comparison.

According to the present invention defined in claim 4, the method of judging deterioration of a battery that supplies electric power to a load comprises the steps of:

comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging the deterioration of the battery on the basis of a result of the comparison,

therefore the deterioration of the battery can be appropriately judged with respect to the predetermined minimum guaranteed dischargeable capacity.

In order to solve the above-mentioned problems, the present invention defined in claim 5 is a method of judging deterioration of a battery that supplies electric power to a load comprising the steps of:

comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging that the battery is deteriorated if the first estimated dischargeable capacity becomes equal to or smaller than the minimum guaranteed dischargeable capacity and the state of charge upon the start of the discharge exceeds a first specific value.

According to the present invention defined in claim 5, the method of judging deterioration of a battery that supplies electric power to a load comprises the steps of:

comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging that the battery is deteriorated if the first estimated dischargeable capacity becomes equal to or smaller than the minimum guaranteed dischargeable capacity and the state of charge upon the start of the discharge exceeds a first specific value,

therefore the deterioration of the battery can be timely judged with respect to the predetermined minimum guaranteed dischargeable capacity.

In order to solve the above-mentioned problems, the present invention defined in claim 6 is a method of judging deterioration of a battery that supplies electric power to a load comprising the steps of:

comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

if the first estimated dischargeable capacity becomes equal to or smaller than the minimum guaranteed dischargeable capacity and the state of charge upon the start of the discharge is equal to or smaller than a first specific value, converting the state of charge that is equal to or smaller than the first specific value into a state of charge of the first specific value;

comparing the minimum guaranteed dischargeable capacity with a second estimated dischargeable capacity, which is estimated for the converted state of charge of the first specific value; and

judging that the battery is deteriorated if the second estimated dischargeable capacity is equal to or smaller than the minimum guaranteed dischargeable capacity.

According to the present invention defined in claim 6, the method of judging deterioration of a battery that supplies electric power to a load comprises the steps of:

comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

if the first estimated dischargeable capacity becomes equal to or smaller than the minimum guaranteed dischargeable capacity and the state of charge upon the start of the discharge is equal to or smaller than a first specific value, converting the state of charge that is equal to or smaller than the first specific value into a state of charge of the first specific value;

comparing the minimum guaranteed dischargeable capacity with a second estimated dischargeable capacity, which is estimated for the converted state of charge of the first specific value; and

judging that the battery is deteriorated if the second estimated dischargeable capacity is equal to or smaller than the minimum guaranteed dischargeable capacity,

therefore the deterioration of the battery can be accurately judged with respect to the predetermined minimum guaranteed dischargeable capacity even in a low state of charge, in which a terminal voltage might be lower than the minimum guaranteed voltage even for a normal battery.

In order to solve the above-mentioned problems, the present invention defined in claim 7 is a method of judging deterioration of a battery that supplies electric power to a load comprising the steps of:

comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging the deterioration of the battery on the basis of a result of the comparison.

According to the present invention defined in claim 7, the method of judging deterioration of a battery that supplies electric power to a load comprises the steps of:

comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging the deterioration of the battery on the basis of a result of the comparison,

therefore the deterioration of the battery can be appropriately judged with respect to the predetermined minimum guaranteed dischargeable capacity taking the error in detecting the dischargeable capacity into consideration as well.

In order to solve the above-mentioned problems, the present invention defined in claim 8 is a method of judging deterioration of a battery that supplies electric power to a load comprising the steps of:

comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging that the battery is deteriorated if the first estimated dischargeable capacity becomes equal to or smaller than the summed value and the state of charge upon the start of the discharge exceeds a first specific value.

According to the present invention defined in claim 8, the method of judging deterioration of a battery that supplies electric power to a load comprises the steps of:

comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

judging that the battery is deteriorated if the first estimated dischargeable capacity becomes equal to or smaller than the summed value and the state of charge upon the start of the discharge exceeds a first specific value,

therefore the deterioration of the battery can be timely judged with respect to the predetermined minimum guaranteed dischargeable capacity taking the error in detecting the dischargeable capacity into consideration as well.

In order to solve the above-mentioned problems, the present invention defined in claim 9 is a method of judging deterioration of a battery that supplies electric power to a load comprising the steps of:

comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

if the first estimated dischargeable capacity becomes equal to or smaller than the summed value and the state of charge upon the start of the discharge is equal to or smaller than a first specific value, converting the state of charge that is equal to or smaller than the first specific value into a state of charge of the first specific value;

comparing the minimum guaranteed dischargeable capacity with a second estimated dischargeable capacity, which is estimated for the converted state of charge of the first specific value; and

judging that the battery is deteriorated if the second estimated dischargeable capacity is equal to or smaller than the summed value.

According to the present invention defined in claim 9, the method of judging deterioration of a battery that supplies electric power to a load comprises the steps of:

comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

if the first estimated dischargeable capacity becomes equal to or smaller than the summed value and the state of charge upon the start of the discharge is equal to or smaller than a first specific value, converting the state of charge that is equal to or smaller than the first specific value into a state of charge of the first specific value;

comparing the minimum guaranteed dischargeable capacity with a second estimated dischargeable capacity, which is estimated for the converted state of charge of the first specific value; and

judging that the battery is deteriorated if the second estimated dischargeable capacity is equal to or smaller than the summed value,

therefore the deterioration of the battery can be accurately judged with respect to the predetermined minimum guaranteed dischargeable capacity taking the error in detecting the dischargeable capacity into consideration as well even in a low state of charge, in which a terminal voltage might be lower than the minimum guaranteed voltage even for a normal battery.

In order to solve the above-mentioned problems, the present invention defined in claim 10 is the method of judging deterioration of a battery as claimed in any one of claims 1-9, wherein the battery is judged deteriorated if the state of charge of the battery becomes equal to or smaller than a second specific value that is set lower than the first specific value.

According to the present invention defined in claim 10, since the battery is judged deteriorated if the state of charge of the battery becomes equal to or smaller than a second specific value that is set lower than the first specific value, therefore when electric power is supplied from the battery to a load in a system, which must be controlled so as not to be in a low state of charge, as for a battery that has been at least once undergone a state of charge lower than the second specific value for a reason that, for example, the battery has been left for a time period longer than a guaranteed time period, the deterioration of the battery can be accurately judged so as to guarantee high reliability in the system.

In order to solve the above-mentioned problems, the present invention defined in claim 11 is the method of judging deterioration of a battery according to 2, 3, 5, 6, 8, 9 or 10, wherein when the battery is judged deteriorated, a display for warning deterioration of the battery is carried out.

According to the present invention defined in claim 11, since a display for warning deterioration of the battery is carried out when the battery is judged deteriorated, therefore a user of the battery can be timely aware of the deterioration of the battery so as to replace the battery with a non-deteriorated battery.

In order to solve the above-mentioned problems, the present invention defined in claim 12 is an apparatus for judging deterioration of a battery that supplies electric power to a load comprising:

storing means for storing a minimum guaranteed voltage predetermined as a minimum value of a terminal voltage of the battery when a given current flows into the load;

voltage drop computing means for computing a voltage drop due to an ohmic resistance and polarization resistance of the battery occurred in response to a discharge of the battery when a given current flows from the battery into the load;

first comparing means for comparing the minimum guaranteed voltage stored in the storing means with a first difference value, which is obtained by subtracting the voltage drop computed by the voltage drop computing means from an open circuit voltage that corresponds to a state of charge upon a start of the discharge of the battery; and

first deterioration judging means for judging that the battery is deteriorated if the first difference value becomes equal to or smaller than the minimum guaranteed voltage and the state of charge upon the start of the discharge exceeds a first specific value as a result of the comparison by the first comparing means.

According to the present invention defined in claim 12, the apparatus for judging deterioration of a battery that supplies electric power to a load comprises:

storing means for storing a minimum guaranteed voltage predetermined as a minimum value of a terminal voltage of the battery when a given current flows into the load;

voltage drop computing means for computing a voltage drop due to an ohmic resistance and polarization resistance of the battery occurred in response to a discharge of the battery when a given current flows from the battery into the load;

first comparing means for comparing the minimum guaranteed voltage stored in the storing means with a first difference value, which is obtained by subtracting the voltage drop computed by the voltage drop computing means from an open circuit voltage that corresponds to a state of charge upon a start of the discharge of the battery; and

first deterioration judging means for judging that the battery is deteriorated if the first difference value becomes equal to or smaller than the minimum guaranteed voltage and the state of charge upon the start of the discharge exceeds a first specific value as a result of the comparison by the first comparing means,

therefore the deterioration of the battery can be timely judged with respect to the predetermined minimum guaranteed voltage.

In order to solve the above-mentioned problems, the present invention defined in claim 13 is an apparatus for judging deterioration of a battery that supplies electric power to a load comprising:

storing means for storing a minimum guaranteed voltage predetermined as a minimum value of a terminal voltage of the battery when a given current flows into the load;

voltage drop computing means for computing a voltage drop due to an ohmic resistance and polarization resistance of the battery occurred in response to a discharge of the battery when a given current flows from the battery into the load;

first comparing means for comparing the minimum guaranteed voltage stored in the storing means with a first difference value, which is obtained by subtracting the voltage drop computed by the voltage drop computing means from an open circuit voltage that corresponds to a state of charge upon a start of the discharge of the battery;

conversion means for converting a state of charge that is equal to or smaller than the first specific value into a state of charge of the first specific value, if the first difference value becomes equal to or smaller than the minimum guaranteed voltage and the state of charge upon the start of the discharge is equal to or smaller than a first specific value as a result of the comparison by the first comparing means;

second comparing means for comparing the minimum guaranteed voltage with a second difference value, which is obtained by subtracting the voltage drop from an open circuit voltage that corresponds to the state of charge of the first specific value converted by the conversion means; and

first deterioration judging means for judging that the battery is deteriorated if the second difference value is equal to or smaller than the minimum guaranteed voltage.

According to the present invention defined in claim 13, the apparatus for judging deterioration of a battery that supplies electric power to a load comprises:

storing means for storing a minimum guaranteed voltage predetermined as a minimum value of a terminal voltage of the battery when a given current flows into the load;

voltage drop computing means for computing a voltage drop due to an ohmic resistance and polarization resistance of the battery occurred in response to a discharge of the battery when a given current flows from the battery into the load;

first comparing means for comparing the minimum guaranteed voltage stored in the storing means with a first difference value, which is obtained by subtracting the voltage drop computed by the voltage drop computing means from an open circuit voltage that corresponds to a state of charge upon a start of the discharge of the battery;

conversion means for converting a state of charge that is equal to or smaller than the first specific value into a state of charge of the first specific value, if the first difference value becomes equal to or smaller than the minimum guaranteed voltage and the state of charge upon the start of the discharge is equal to or smaller than a first specific value as a result of the comparison by the first comparing means;

second comparing means for comparing the minimum guaranteed voltage with a second difference value, which is obtained by subtracting the voltage drop from an open circuit voltage that corresponds to the state of charge of the first specific value converted by the conversion means; and

first deterioration judging means for judging that the battery is deteriorated if the second difference value is equal to or smaller than the minimum guaranteed voltage,

therefore the deterioration of the battery can be accurately judged with respect to the predetermined minimum guaranteed voltage even in a low state of charge, in which a terminal voltage might be lower than the minimum guaranteed voltage even for a normal battery.

In order to solve the above-mentioned problems, the present invention defined in claim 14 is an apparatus for judging deterioration of a battery that supplies electric power to a load comprising:

storing means for storing a minimum guaranteed dischargeable capacity predetermined for supplying an electrical quantity required at the minimum to the load for .a specific period of time when a given current flows into the load,

voltage drop computing means for computing a voltage drop due to an ohmic resistance and polarization resistance of the battery occurred in response to a discharge of the battery when a given current flows from the battery into the load;

third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

first deterioration judging means for judging that the battery is deteriorated if the first estimated dischargeable capacity becomes equal to or smaller than the minimum guaranteed dischargeable capacity and the state of charge upon the start of the discharge exceeds a first specific value as a result of the comparison by the third comparing means.

According to the present invention defined in claim 14, the apparatus for judging deterioration of a battery that supplies electric power to a load comprises:

storing means for storing a minimum guaranteed dischargeable capacity predetermined for supplying an electrical quantity required at the minimum to the load for a specific period of time when a given current flows into the load,

voltage drop computing means for computing a voltage drop due to an ohmic resistance and polarization resistance of the battery occurred in response to a discharge of the battery when a given current flows from the battery into the load;

third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

first deterioration judging means for judging that the battery is deteriorated if the first estimated dischargeable capacity becomes equal to or smaller than the minimum guaranteed dischargeable capacity and the state of charge upon the start of the discharge exceeds a first specific value as a result of the comparison by the third comparing means,

therefore the deterioration of the battery can be timely judged with respect to the predetermined minimum guaranteed dischargeable capacity.

In order to solve the above-mentioned problems, the present invention defined in claim 15 is an apparatus for judging deterioration of a battery that supplies electric power to a load comprising:

storing means for storing a minimum guaranteed dischargeable capacity predetermined for supplying an electrical quantity required at the minimum to the load for a specific period of time when a given current flows into the load,

voltage drop computing means for computing a voltage drop due to an ohmic resistance and polarization resistance of the battery occurred in response to a discharge of the battery when a given current flows from the battery into the load;

third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

conversion means for converting a state of charge that is equal to or smaller than the first specific value into a state of charge of the first specific value, if the first estimated dischargeable capacity becomes equal to or smaller than the minimum guaranteed dischargeable capacity and the state of charge upon the start of the discharge exceeds a first specific value as a result of the comparison by the third comparing means;

fourth comparing means for comparing the minimum guaranteed dischargeable capacity with a second estimated dischargeable capacity, which is estimated for the state of charge of the first specific value converted by the conversion means; and

first deterioration judging means for judging that the battery is deteriorated if the second estimated dischargeable capacity is equal to or smaller than the minimum guaranteed dischargeable capacity.

According to the present invention defined in claim 15, the apparatus for judging deterioration of a battery that supplies electric power to a load comprises:

storing means for storing a minimum guaranteed dischargeable capacity predetermined for supplying an electrical quantity required at the minimum to the load for a specific period of time when a given current flows into the load,

voltage drop computing means for computing a voltage drop due to an ohmic resistance and polarization resistance of the battery occurred in response to a discharge of the battery when a given current flows from the battery into the load;

third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

conversion means for converting a state of charge that is equal to or smaller than the first specific value into a state of charge of the first specific value, if the first estimated dischargeable capacity becomes equal to or smaller than the minimum guaranteed dischargeable capacity and the state of charge upon the start of the discharge exceeds a first specific value as a result of the comparison by the third comparing means;

fourth comparing means for comparing the minimum guaranteed dischargeable capacity with a second estimated dischargeable capacity, which is estimated for the state of charge of the first specific value converted by the conversion means; and

first deterioration judging means for judging that the battery is deteriorated if the second estimated dischargeable capacity is equal to or smaller than the minimum guaranteed dischargeable capacity, therefore the deterioration of the battery can be accurately judged with respect to the predetermined minimum guaranteed dischargeable capacity even in a low state of charge, in which a terminal voltage might be lower than the minimum guaranteed voltage even for a normal battery.

In order to solve the above-mentioned problems, the present invention defined in claim 16 is an apparatus for judging deterioration of a battery that supplies electric power to a load comprising:

storing means for storing (a) a minimum guaranteed dischargeable capacity predetermined for supplying an electrical quantity required at the minimum to the load for a specific period of time when a given current flows into the load and (b) an error in detecting the dischargeable capacity;

voltage drop computing means for computing a voltage drop due to an ohmic resistance and polarization resistance of the battery occurred in response to a discharge of the battery when a given current flows from the battery into the load;

third comparing means for comparing a summed value of (a) the minimum guaranteed dischargeable capacity stored in the storing means and (b) the error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

first deterioration judging means for judging that the battery is deteriorated if the first estimated dischargeable capacity becomes equal to or smaller than the summed value and the state of charge upon the start of the discharge exceeds a first specific value as a result of the comparison by the third comparing means.

According to the present invention defined in claim 16, the apparatus for judging deterioration of a battery that supplies electric power to a load comprises:

storing means for storing (a) a minimum guaranteed dischargeable capacity predetermined for supplying an electrical quantity required at the minimum to the load for a specific period of time when a given current flows into the load and (b) an error in detecting the dischargeable capacity;

voltage drop computing means for computing a voltage drop due to an ohmic resistance and polarization resistance of the battery occurred in response to a discharge of the battery when a given current flows from the battery into the load;

third comparing means for comparing a summed value of (a) the minimum guaranteed dischargeable capacity stored in the storing means and (b) the error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and

first deterioration judging means for judging that the battery is deteriorated if the first estimated dischargeable capacity becomes equal to or smaller than the summed value and the state of charge upon the start of the discharge exceeds a first specific value as a result of the comparison by the third comparing means,

therefore the deterioration of the battery can be timely judged with respect to the predetermined minimum guaranteed dischargeable capacity taking the error in detecting the dischargeable capacity into consideration as well.

In order to solve the above-mentioned problems, the present invention defined in claim 17 is an apparatus for judging deterioration of a battery that supplies electric power to a load comprising:

storing means for storing (a) a minimum guaranteed dischargeable capacity predetermined for supplying an electrical quantity required at the minimum to the load for a specific period of time when a given current flows into the load and (b) an error in detecting the dischargeable capacity;

voltage drop computing means for computing a voltage drop due to an ohmic resistance and polarization resistance of the battery occurred in response to a discharge of the battery when a given current flows from the battery into the load;

third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

conversion means for converting a state of charge that is equal to or smaller than a first specific value into a state of charge of the first specific value, if the first estimated dischargeable capacity becomes equal to or smaller than a summed value of (a) the minimum guaranteed dischargeable capacity and (b) the error in detecting the dischargeable capacity stored in the storing means and the state of charge upon the start of the discharge is equal to or smaller than a first specific value as a result of the comparison by the third comparing means;

fourth comparing means for comparing the minimum guaranteed dischargeable capacity with a second estimated dischargeable capacity, which is estimated for the state of charge of the first specific value converted by the conversion means; and

first deterioration judging means for judging that the battery is deteriorated if the second estimated dischargeable capacity is equal to or smaller than the summed value.

According to the present invention defined in claim 17, the apparatus for judging deterioration of a battery that supplies electric power to a load comprises:

storing means for storing (a) a minimum guaranteed dischargeable capacity predetermined for supplying an electrical quantity required at the minimum to the load for a specific period of time when a given current flows into the load and (b) an error in detecting the dischargeable capacity;

voltage drop computing means for computing a voltage drop due to an ohmic resistance and polarization resistance of the battery occurred in response to a discharge of the battery when a given current flows from the battery into the load;

third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;

conversion means for converting a state of charge that is equal to or smaller than a first specific value into a state of charge of the first specific value, if the first estimated dischargeable capacity becomes equal to or smaller than a summed value of (a) the minimum guaranteed dischargeable capacity and (b) the error in detecting the dischargeable capacity stored in the storing means and the state of charge upon the start of the discharge is equal to or smaller than a first specific value as a result of the comparison by the third comparing means;

fourth comparing means for comparing the minimum guaranteed dischargeable capacity with a second estimated dischargeable capacity, which is estimated for the state of charge of the first specific value converted by the conversion means; and

first deterioration judging means for judging that the battery is deteriorated if the second estimated dischargeable capacity is equal to or smaller than the summed value,

therefore the deterioration of the battery can be accurately judged with respect to the predetermined minimum guaranteed dischargeable capacity even in a low state of charge, in which a terminal voltage is lower than the minimum guaranteed voltage even for a normal battery taking the error in detecting the dischargeable capacity into consideration as well.

In order to solve the above-mentioned problems, the present invention defined in claim 18 is the apparatus for judging deterioration of a battery as claimed in any one of claims 12-17, further comprising second deterioration judging means for judging that the battery is deteriorated if the state of charge of the battery becomes equal to or smaller than a second specific value that is set lower than the first specific value.

According to the present invention defined in claim 18, since the apparatus further comprises second deterioration judging means for judging that the battery is deteriorated if the state of charge of the battery becomes equal to or smaller than a second specific value that is set lower than the first specific value, therefore when electric power is supplied from the battery to a load in a system, which must be controlled so as not to be in a low state of charge, as for a battery that has been at least once undergone a state of charge lower than the second specific value for a reason that, for example, the battery has been left for a time period longer than a guaranteed time period, the deterioration of the battery can be accurately judged so as to guarantee high reliability in the system.

In order to solve the above-mentioned problems, the present invention defined in claim 19 is the apparatus for judging deterioration of a battery as claimed in any one of claims 12-18, further comprising warning display means for carrying out a display for warning deterioration of the battery when the battery is judged deteriorated.

According to the present invention defined in claim 19, since the apparatus further comprises warning display means for carrying out a display for warning deterioration of the battery when the battery is judged deteriorated, therefore a user of the battery can be timely aware of the deterioration of the battery so as to replace the battery with a non-deteriorated battery.

### BRIEF DESCRIPTION OF THE DRAWINGS

FIG. 1 is a block diagram illustrating a primary constitution of an on-vehicle battery control system including an apparatus for judging deterioration of a battery, which puts a method of judging deterioration of a battery according to a preferred embodiment of the present invention into practice.

FIG. 2 is a flow chart illustrating a deterioration judging processing of a battery, which processing is performed by a CPU according to a control program stored in a ROM in the on-vehicle battery control system shown in FIG. 1.

FIG. 3 is a flow chart illustrating a subroutine of a deterioration judging processing of a battery with a minimum guaranteed voltage in the flow chart shown in FIG. 2.

FIG. 4 is a flow chart illustrating a subroutine of a deterioration judging processing of a battery with a dischargeable capacity in the flow chart shown in FIG. 2.

FIG. 5 is an illustration of setting the minimum guaranteed voltage and the minimum guaranteed dischargeable capacity.

FIG. 6 is an illustration of converting a state of charge (SOC).

FIG. 7 is a flow chart illustrating another example of a subroutine of a deterioration judging processing of a battery with a dischargeable capacity, which is similar to the flow chart shown in FIG. 4.

FIG. 8 is a graph illustrating an example of a discharge current including a rush current when a starter motor is started to drive.

FIG. 9 is a graph illustrating an example of an I-V characteristic expressed by a quadratic approximate expression.

FIG. 10 is a graph illustrating an example of a way how to remove the concentration polarization component from an approximate expression upon current-increase.

FIG. 11 is a graph illustrating an example of a way how to remove the concentration polarization component from an approximate expression upon current-decrease.

FIG. 12 is a graph illustrating an example of an I-V characteristic expressed by a linear approximate expression upon current-increase.

FIG. 13 is a graph illustrating another example of a way how to remove the concentration polarization component from an approximate expression upon current-decrease.

FIG. 14 is a graph illustrating a further example of a way how to remove the concentration polarization component from an approximate expression upon current-decrease.

FIG. 15 is a graph illustrating a way how to compute the saturation polarization during a discharge in an equilibrium state or in a state in which the discharge polarization takes place.

FIG. 16 is a graph illustrating a way how to compute the saturation polarization during a discharge in a state in which the charge polarization takes place.

FIG. 17 is a graph illustrating a way how to compute the saturation polarization during a discharge in a state in which the discharge polarization or the charge polarization takes place.

FIG. 18 is a graph illustrating a voltage drop occurred inside the battery during a discharge.

FIG. 19 is a graph illustrating a voltage upon fully charged state and a voltage upon completion of a discharge.

### BEST MODE FOR CARRYING OUT THE INVENTION

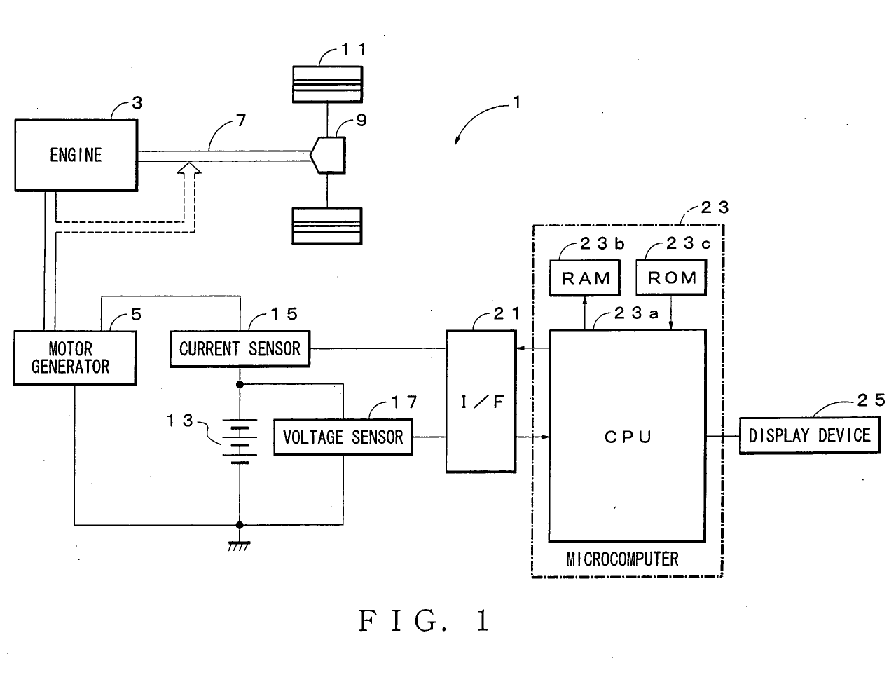

In the following, preferred embodiments of the present invention will be explained with reference to the attached drawings. FIG. 1 is a block diagram illustrating a primary constitution of an on-vehicle battery control system including an apparatus for judging deterioration of a battery, which puts a method of judging deterioration of a battery according to a preferred embodiment of the present invention into practice.

In FIG. 1, an on-vehicle battery control system 1 is mounted on a hybrid vehicle which includes an engine 3 and motor generator 5.

Normally, only an output of the engine 3 is transmitted from a drive shaft 7 to wheels 11 via differential case 9 so as to drive the vehicle, on the other hand, upon traveling with high load, the motor generator 5 functions as a motor by an electric power from a battery 13, for example, lead battery 13 so that an output of the motor generator 5 together with the output of the engine 3 is transmitted from the drive shaft 7 to the wheels 11, thereby an assistant driving is carried out.

In this hybrid vehicle, the motor generator 5 functions as a generator upon the decelerating or braking so as to convert the kinetic energy to the electric energy, thereby the battery 13 is charged.

Further, the motor generator 5 is used as a starter motor, which forcibly rotates a flywheel of the engine 3, upon the start of the engine 3 in response to the switching on of a starter switch (not shown in the figure). In this case, a large current flows into the motor generator 5 in a short period of time. When the engine 3 is started by the motor generator 5 after the starter switch is switched on, in response to the cancel of the operation of the ignition key (not shown in the figure), the starter switch is turned off, thereby the ignition switch and the accessory switches are switched on and a discharge current flowing from the battery 13 becomes a steady-state current.

The on-vehicle battery control system 1 according to this preferred embodiment comprises: a current sensor 15 for detecting a charge or discharge current of the battery 13 flowing from the motor generator 5 that functions as a generator and a discharge current I of the battery 13 flowing into electrical equipment such as the motor for the assistant driving and the motor generator 5 that functions as a starter motor; and a voltage sensor 17 having a resistance of about 1 MΩ connected in parallel to the battery 13 for detecting the terminal voltage V of the battery 13.

The on-vehicle battery control system 1 according to this preferred embodiment further comprises a microcomputer 23, into which outputs of the current sensor 15 and voltage sensor 17 are stored after their analog/digital (hereinafter, A/D) conversion performed in an interface circuit 21 (hereinafter, I/F 21).

The microcomputer 23 comprises a CPU 23a, which functions as the voltage drop computing means, first comparing means, conversion means, second comparing means, third comparing means, first and second deterioration judging means, RAM 23b, and ROM 23c that functions as the storing means. The CPU 23a also functions as the internal resistance monitoring means and dischargeable capacity monitoring means. The CPU 23a is connected to the I/F 21 and a display device 25 that functions as the warning display means besides being connected to the RAM 23b and ROM 23c. The CPU 23a is also connected to the starter switch, ignition switch, accessory switches and switches of the electrical equipment (loads) except the motor generator 5.

The RAM 23b has a data area for storing various data and a work area for use in various processings. Control programs for making the CPU 23a implement various processings are installed in the ROM 23c.

In the ROM 23c, various data are recorded writably and readably, and there is provided a nonvolatile storage (not shown in the figure) for holding the recorded data without an electric power source, in which nonvolatile storage various basic data and updated data for the battery 13 are held. For example, the nonvolatile storage in advance stores basic data such as an open circuit voltage upon fully charged state (OCVf; expressed in V (volt) unit) of the battery 13 upon its non-deteriorated state (i.e. new battery or battery upon designing), an open circuit voltage upon completion of discharge (OCVe; expressed in V unit), an initial electrical quantity (SOCf; expressed in Ah (ampere·hour) unit) that is a total electrical quantity chargeable or dischargeable between OCVf and OCVe and so on.

Further, the nonvolatile storage in advance stores data as to values of an ohmic resistance and polarization resistance (activation polarization resistance and concentration polarization resistance) on a specific discharge current value of the battery 13 upon its non-deteriorated state (i.e. new battery or battery upon designing).

Furthermore, the nonvolatile storage in advance stores: a minimum guaranteed voltage predetermined as a minimum value of a terminal voltage of the battery when a given current flows into the load; and a minimum guaranteed dischargeable capacity (dischargeable capacity=ADC) of the battery predetermined to supply an electrical quantity required at the minimum to the load for a specific period of time when a given current flows into the load. The minimum guaranteed voltage and the minimum guaranteed dischargeable capacity are predetermined in accordance with a form of the load to which an electric power is supplied from the battery 13.

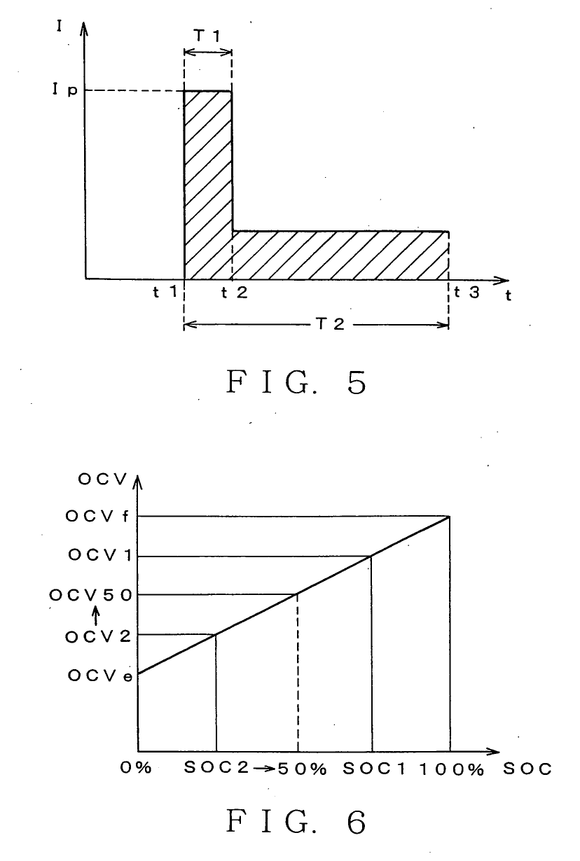

For example, as shown in FIG. 5, in a case that the load to which an electric power is supplied from the battery 13 has such a characteristic that a large current flows for a short time period T1 from time t1 to time t2 and thereafter a small current flows for a time period T2-T1 (that is, T2 being a duration time) from time t2 to time t3, the terminal voltage of the battery 13 rapidly decreases for the short time period T1 while the large current flows. In order that this rapid decrease in the terminal voltage never affects the operation of the load, when a value is required, the terminal voltage of the battery 13 never becoming lower than said value, said value is set (i.e. determined) as the minimum guaranteed voltage.

Further, a dischargeable capacity of the battery 13 to supply an electrical quantity required at the minimum to the load for keeping the operation of the load for the duration time T2 is set (i.e. determined) as the minimum guaranteed dischargeable capacity. This minimum guaranteed dischargeable capacity is expressed in Ah (ampere·hour) unit, which capacity is shown with an area indicated by diagonal lines in FIG. 5.

The current values and voltage values, which are the outputs from the current sensor 15 and voltage sensor 17, respectively, are taken into the CPU 23a of the microcomputer 23 through the I/F 21, then stored in a data area (corresponding to the storing means) of the RAM 23b regarding the current values and voltage values from those before a specific period of time to those updated. These stored real data are used to measure the ohmic resistance and polarization resistance of the battery, by which the deterioration of the battery is judged.

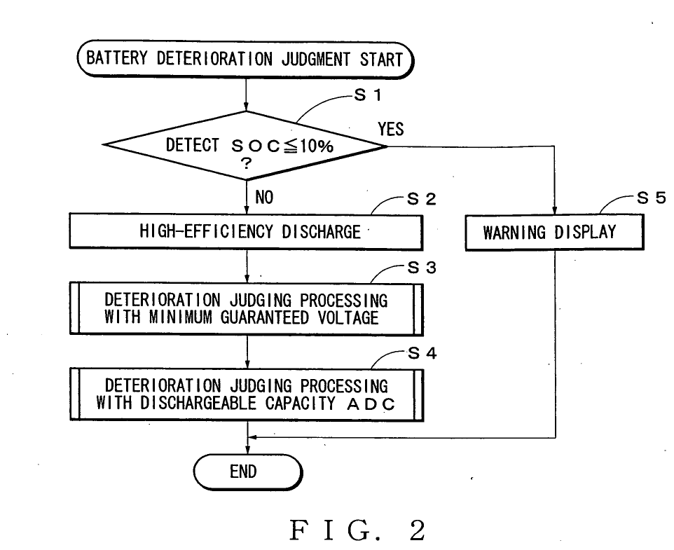

In the following, a battery deterioration judging processing that the CPU 23a carries out according to a control program stored in the ROM 23c will be explained with reference to flow charts shown in FIGS. 2-4.

Starting an action with switching-on of the ignition switch, the CPU 23a first in step S1 in FIG. 2 judges whether or not the state of charge (SOC) of the battery 13 is detected to become a low SOC equal to or lower than a second specific value (for example, 10% in this preferred embodiment; however this value being changeable according to a situation) (step S1).

Generally, as for the battery 13 upon designing, that is, the battery 13 upon non-deteriorated, an open circuit voltage upon fully charged state (OCVf; expressed in V (volt) unit), an open circuit voltage upon completion of discharge (OCVe; expressed in V unit), and an initial electrical quantity (SOCf; expressed in Ah (ampere·hour) unit) that is a total electrical quantity chargeable or dischargeable between OCVf and OCVe can be predetermined. From their relation, if an open circuit voltage (OCV) at a given time point is known, a state of charge (SOC) that is an electrical quantity corresponding to the known OCV can be known. In reverse, if a SOC at a given time point is known, an OCV that corresponds to the known SOC can be known.

Therefore, upon a discharge of the battery 13, OCV just before and just after the discharge are measured so that SOC of the battery 13 at that time point are obtained, thereby the judgment described above can be carried out.

At step S1, if the answer is YES, the battery 13 is judged deteriorated and the display device 25 displays a warning display indicating a necessity of replacement of the battery 13. That is, in a system in which a control is carried out so that the terminal voltage of the battery 13 never becomes a low SOC state when the battery 13 is utilized, in the event that once the terminal voltage of the battery 13 undergoes a low SOC equal to or lower than a specific value because of a reason that, for example, the battery has been left for a time period longer than a guaranteed time period, the reliable system should judge that the battery must be replaced. Then, a user can confirm the warning display of the display device 25, so that the user can replace the battery 13 with a non-deteriorated new battery.

On the other hand, at step S1, if the answer is NO, a high-efficiency discharge is carried out (step S2), then a deterioration judging processing with the minimum guaranteed voltage is carried out (step S3) and then, a deterioration judging processing with the dischargeable capacity is carried out (step S4).

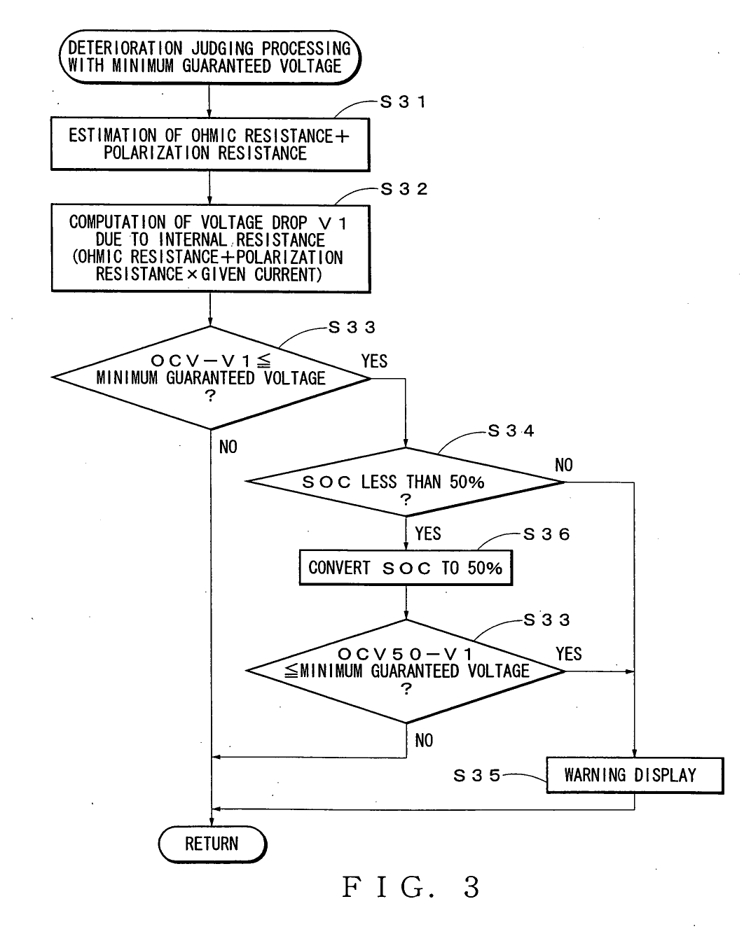

FIG. 3 is a flow chart illustrating a subroutine of the deterioration judging processing of the battery with the minimum guaranteed voltage, which is carried out at step S3 in the flow chart shown in FIG. 2. In the flow chart shown in FIG. 3, first an estimation of the internal resistance (ohmic resistance+polarization resistance) of the battery 13 is carried out (step S31), then a computation of the voltage drop component due to the internal resistance (ohmic resistance+polarization resistance) is carried out (step S32). This voltage drop component (V1) is expressed by the following expression:
V1=(ohmic resistance+polarization resistance)×(give current),
wherein the give current means a discharge current that flows into a load from the battery 13 during the discharge.

Thereafter, it is judged whether or not (OCV−V1) is equal to or less than the minimum guaranteed voltage (for example, 10 volts) (step S33). For example, if the minimum guaranteed voltage is set 10 volts upon a discharge when 10 A (amperes) flows as the given current, it is judged whether or not (OCV−V1) is equal to or less than 10 volts. If the answer is NO, the process returns back to step S4 in FIG. 2, on the other hand, if the answer is YES, the process advances to step S34.

At step S34, it is judged whether or not the SOC is less than a first specific value (for example, 50% in this preferred embodiment; however this value being changeable according to a situation). If the answer is NO, the battery 13 is judged deteriorated and the display device 25 displays a s warning display indicating a necessity of replacement of the battery 13 (step S35).

For example, by carrying out a high-efficiency discharge, as shown in FIG. 6, when the SOC1 estimated just after a discharge is equal to or more than 50%, if an estimation that the (OCV−V1) is less than the minimum guaranteed voltage (for example, 10 volts) is done despite that the SOC is equal to or more than 50%, it is judged that the battery 13 must be replaced. Then, a user can confirm the warning display of the display device 25, so that the user can replace the battery 13 with a non-deteriorated new battery.

On the other hand, at step S34, if the answer is YES, the SOC that is less than 50% is converted to a SOC that is 50% (step S36). Here, a charge may be carried out so that the SOC that is less than 50% becomes 50%, however, in this preferred embodiment, the SOC that is less than 50% is converted to a SOC that is 50%. That is, as shown in FIG. 6, when the SOC2 estimated from an OCV2 measured just after a discharge is less than 50%, the SOC2 is converted to a SOC that is 50%, computing as an OCV50 with respect to the SOC that is 50%.

Thereafter, it is judged whether or not (OCV50−V1) is equal to or less than the minimum guaranteed voltage (for example, 10 volts) (step S37). For example, if the SOC is low and equal to or less than 50%, the terminal voltage might be less than the minimum guaranteed voltage even for a normal battery, accordingly the low SOC is converted to a SOC that is 50%, thereby carrying out the deterioration judgment.

Then, if the answer at step S37 is NO, the process returns back to step S4 in FIG. 2, on the other hand, if the answer at step S37 is YES, the process advances to step S35. At step 35, the display device 25 displays a warning display indicating a necessity of replacement of the battery 13. Then, a user can confirm the warning display of the display device 25, so that the user can replace the battery 13 with a non-deteriorated new battery.

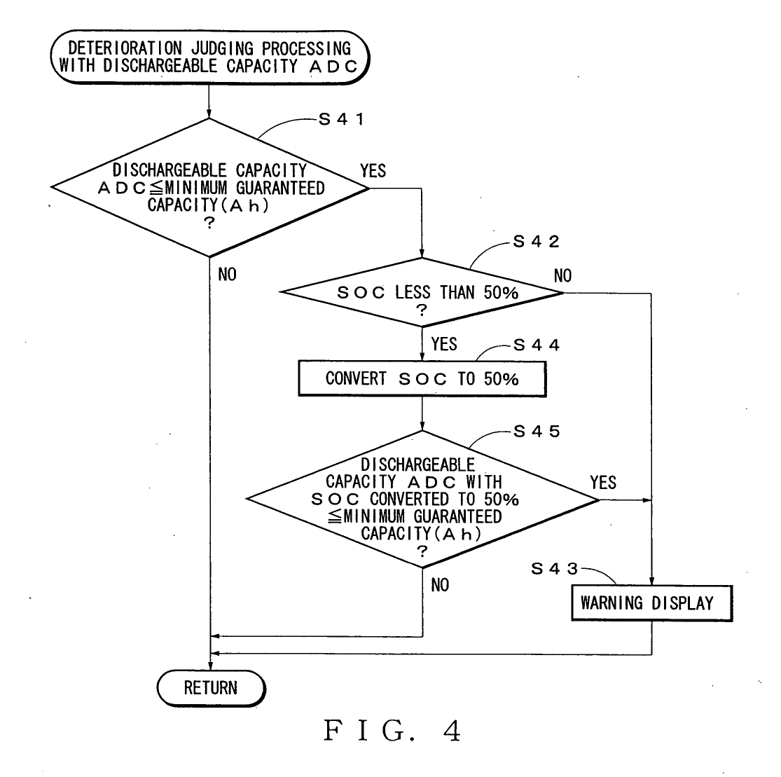

FIG. 4 is a flow chart illustrating a subroutine of a deterioration judging processing of a battery with a dischargeable capacity, which is carried out at step 4 in the flow chart shown in FIG. 2.

In the flow chart shown in FIG. 4, first it is judged whether or not the dischargeable capacity of the battery just after carrying out a high-efficiency discharge is equal to or less than the minimum guaranteed dischargeable capacity (in Ah unit) (step S41). For example, the minimum guaranteed dischargeable capacity is set 3A (three amperes), it is judged whether or not the dischargeable capacity is equal to or less than 3A.

If the answer at step S41 is NO, the process returns back to the flow chart shown in FIG. 2 so as to finish the processing, on the other hand, if the answer at step S41 is YES, the process advances to step S42.

At step S42, it is judged whether or not the SOC is less than 50%. If the answer is NO, the battery 13 is judged deteriorated and the display device 25 displays a warning display indicating a necessity of replacement of the battery 13 (step S43). That is, if an estimation that the SOC is less than the minimum guaranteed dischargeable capacity is done despite that the SOC is equal to or more than 50%, it is judged that the battery 13 must be replaced. Then, a user can confirm the warning display of the display device 25, so that the user can replace the battery 13 with a non-deteriorated new battery.

On the other hand, at step S42, if the answer is YES, the SOC that is less than 50% is converted to a SOC that is 50% (step S44). Here, a charge may be carried out so that the SOC that is less than 50% becomes 50%, however, in this preferred embodiment, the SOC that is less than 50% is converted to a SOC that is 50%.

Thereafter, it is judged whether or not the dischargeable capacity converted to a SOC that is 50% is equal to or less than the minimum guaranteed dischargeable capacity (step S45). Here, if the SOC is low and equal to or less than 50%, the terminal voltage might be less than the minimum guaranteed voltage even for a normal battery, accordingly the low SOC is converted to a SOC that is 50%, thereby carrying out the deterioration judgment.

If the answer at step S45 is NO, the process returns back to the flow chart shown in FIG. 2 so as to finish the processing, on the other hand, if the answer at step S45 is YES, the process advances to step S43, the battery 13 is judged deteriorated and the display device 25 displays a warning display indicating a necessity of replacement of the battery 13. Then, a user can confirm the warning display of the display device 25, so that the user can replace the battery 13 with a non-deteriorated new battery.

Thus, the judgment of the deterioration of the battery 13 can be carried out by using the minimum guaranteed voltage or the minimum guaranteed dischargeable capacity as a criterion, so that if the battery 13 is judged deteriorated, the user can promptly replace the battery 13 with a non-deteriorated new battery.

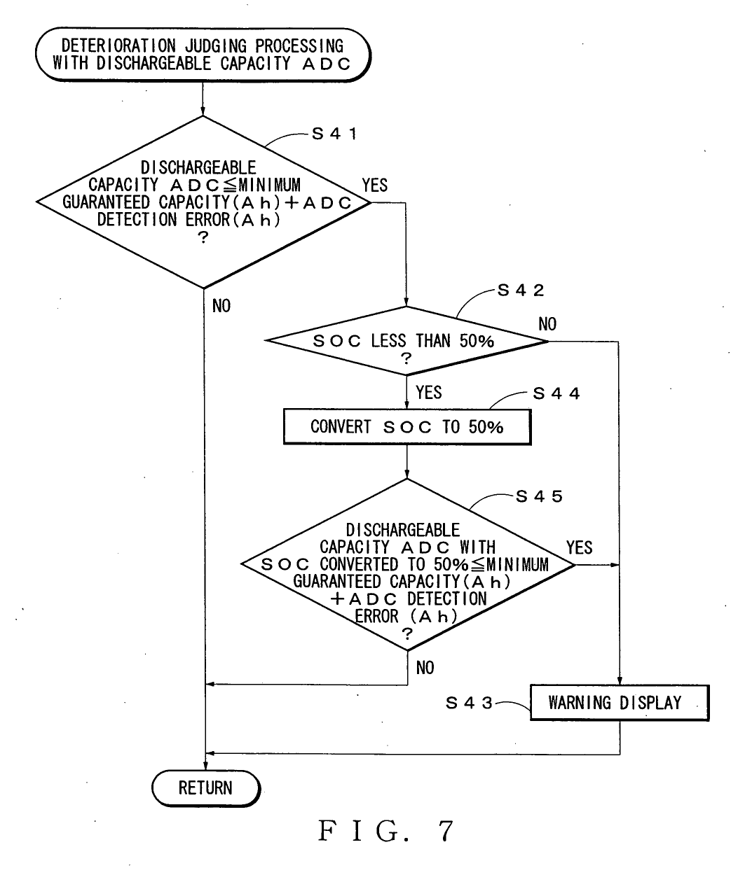

FIG. 7 is a flow chart illustrating another example of a subroutine of a deterioration judging processing of a battery with a dischargeable capacity, which is similar to the flow chart shown in FIG. 4.

In the flow chart shown in FIG. 7, first it is judged whether or not the dischargeable capacity of the battery just after carrying out a high-efficiency discharge is equal to or less than a summed value of the minimum guaranteed dischargeable capacity (in Ah unit) and an error (in Ah unit) in detecting the dischargeable capacity (step S41).

Here, the error in detecting the dischargeable capacity is an error allowable upon detecting the dischargeable capacity. For example, as for a battery having a total electric quantity of 20 Ah, when the minimum guaranteed dischargeable capacity is set to be 3 Ah, (estimated detection accuracy of dischargeable capacity ±5%=20 Ah×±0.05=±1 Ah) is added to the 3 Ah. That is, if a guarantee for a value of an estimated dischargeable capacity is ±5%, it might be possible that an estimation having an error of −5% is done.

At step S41, for example, it is judged whether or not the dischargeable capacity after carrying out a high-efficiency discharge is equal to or less than [3 Ah (the minimum guaranteed dischargeable capacity)+1 Ah (detection error)]=4 Ah.

If the answer at step S41 is NO, the process returns back to the flow chart shown in FIG. 2 so as to finish the processing, on the other hand, if the answer at step S41 is YES, the process advances to step S42.

At step S42, it is judged whether or not the SOC is less than 50%. If the answer is NO, the battery 13 is judged deteriorated and the display device 25 displays a warning display indicating a necessity of replacement of the battery 13 (step S43). Then, a user can confirm the warning display of the display device 25, so that the user can replace the battery 13 with a non-deteriorated new battery.

On the other hand, at step S42, if the answer is YES, the SOC that is less than 50% is converted to a SOC that is 50% (step S44).

Thereafter, it is judged whether or not the dischargeable capacity converted to a SOC that is 50% is equal to or less than the summed value of (the minimum guaranteed dischargeable capacity+an error in detecting the dischargeable capacity) (step S45). For example, it is judged whether or not the dischargeable capacity converted to a SOC that is 50% is equal to or less than the summed value of [3 Ah (the minimum guaranteed dischargeable capacity)+1 Ah (detection error)]. If the answer at step S45 is NO, the process returns back to the flow chart shown in FIG. 2 so as to finish the processing, on the other hand, if the answer at step S45 is YES, the process advances to step S43.

At step 43, the display device 25 displays a warning display indicating a necessity of replacement of the battery 13. Then, a user can confirm the warning display of the display device 25, so that the user can replace the battery 13 with a non-deteriorated new battery.

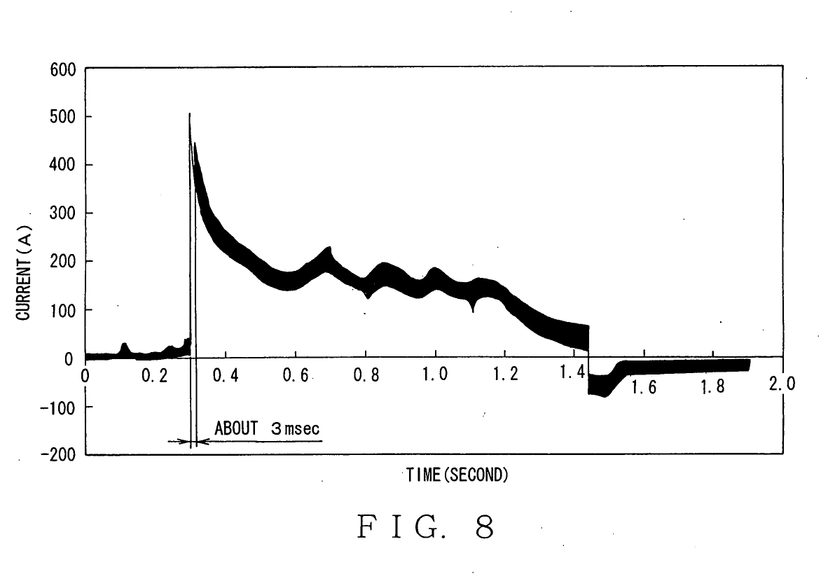

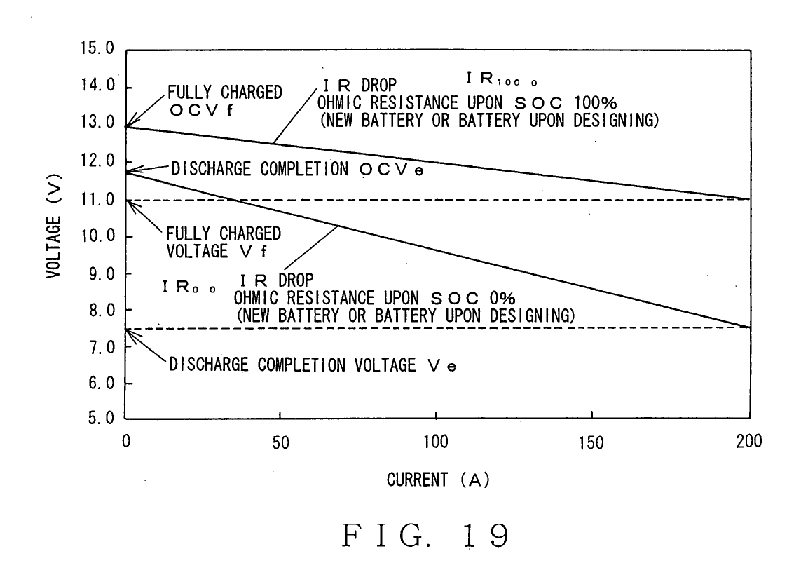

In the following, a method of measuring parameters (that is, ohmic resistance, saturation polarization and dischargeable capacity) of the battery 13, which are used in the deterioration judging processing described above will be explained with reference to FIGS. 8-19.

As the load that receives electric power from a battery so as to act, a load that requires a large current such as a starter motor, motor generator or motor for traveling is mounted on a 12V-vehicle, 42V-vehicle, EV vehicle and HEV vehicle. For example, when a starter motor or a constant load requiring a large current is switched-on, first a rush current flows into the load at an initial stage when such a drive starts, thereafter a current having a steady-state value according to the magnitude of the load flows into the load.

If a direct-current motor is used as the starter motor, as shown in FIG. 8, a rush current that flows into a field coil monotonously increases from about zero to a peak value that is significantly larger than the steady-state current, for example, 500 A (amperes) within a short period of time, for example, 3 msec (milliseconds) just after the start of the drive with the constant load, thereafter the rush current monotonously decreases from the peak value down to a steady-state value according to the magnitude of the constant load within a short period of time, for example, 150 msec, thereby being supplied from the battery as a discharge current. Therefore, when the rush current flows into the constant load, the discharge current of the battery and a terminal voltage corresponding to the discharge current are measured, so that a discharge current—terminal voltage characteristic (i.e. I-V characteristic) of the battery, which characteristic exhibits a change in the terminal voltage with respect to a current change over a wide range from zero to the peak value, can be measured.

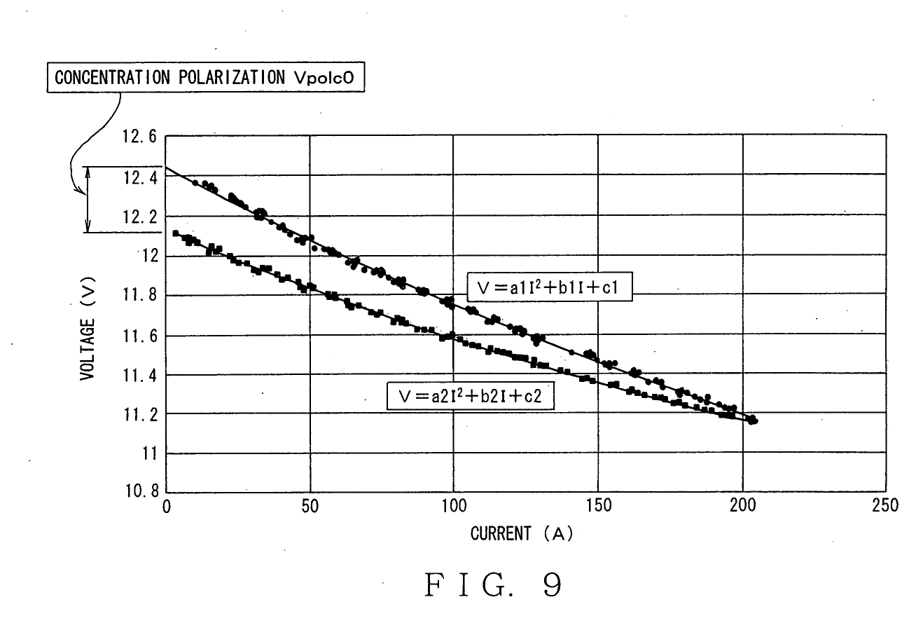

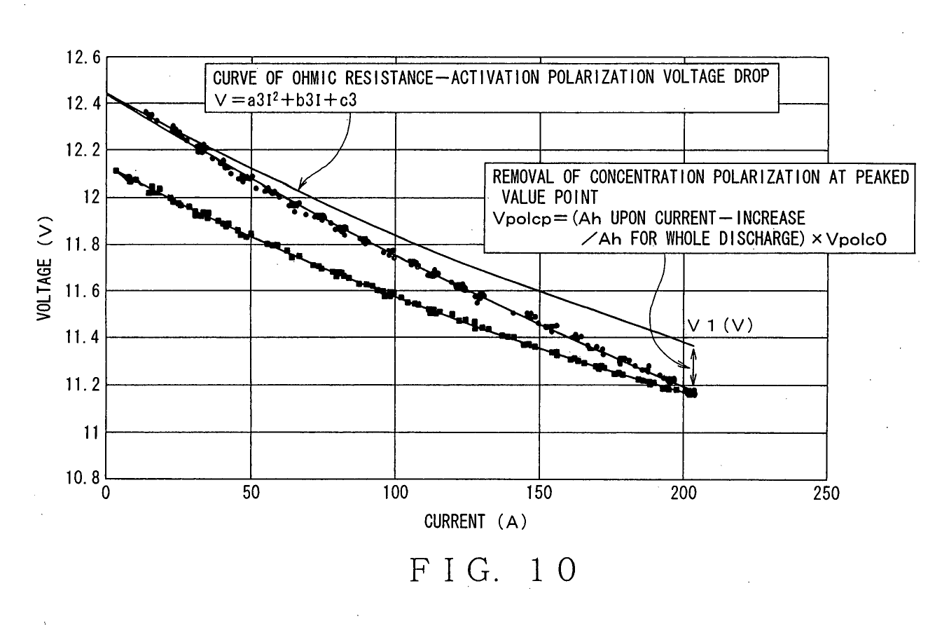

As a simulative discharge corresponding to a rush current that flows when the starter motor is switched-on, the battery is subjected to a discharge by using an electronic load, in which discharge the current increases from zero to about 200 A in 0.25 seconds, then decreases from the peak value to zero in 0.25 seconds. During the discharge as described above, the discharge current and terminal voltage of the battery as a pair is measured with a short constant period and thus obtained paired data are plotted with a lateral axis being the discharge current and a longitudinal axis being the terminal voltage, thereby obtaining a graph shown in FIG. 9. The I-V characteristic upon increase and decrease in the discharge current shown in a graph in FIG. 9 can be approximated by the following quadratic expressions by using least squares method:
V=a1I²+b1I+c1 (1)
V=a2I²+b2I+c2 (2).

In FIG. 9, curves of the quadratic approximation expressions described above are also drawn.

In FIG. 9, the voltage difference (c1−c2), that is a difference between an intercept of the approximation curve of current-increase and an intercept of the approximation curve of current-decrease, is a voltage difference at I=0 when the current does not flow. Therefore, this voltage difference (c1−c2) is considered to be a voltage drop due to only concentration polarization newly occurred because of the discharge, which does not include a voltage drop due to ohmic resistance and activation polarization. This concentration polarization at current=0 A (zero ampere) is expressed as Vpolc0. Generally, any concentration polarization is proportional to a product obtained by multiplying the magnitude of a current by a time period in which the current flows, that is, Ah (hereinafter expressed by Asec (ampere·second) since the time period being short).

In the following, a method of computing the concentration polarization at the current=the peak value by using the concentration polarization Vpolc0 at current=0 A. If the concentration polarization at the current=the peak value is expressed by Vpolcp, the Vpolcp is expressed by the following:

$$Vpolcp = [ ( Asec upon current \text{-} increase ) / ( Asec for whole discharge ) ] \times Vpolco . \qquad ( 3 )$$

Here, the Asec for whole discharge is expressed by the following:
Asec for whole discharge=(Asec upon current-increase+Asec upon current-decrease).

The concentration polarization Vpolcp at the current=the peak value computed as described above is added to the voltage at the peak value upon current-increase in the expression (1), so that as shown in FIG. 10, the concentration polarization at the peak value is removed. If the voltage after the concentration polarization at the peak value is removed is expressed as V1, the V1 is expressed as follows:
V1=a1Ip²+b1Ip+c1+Vpolcp.
Here, Ip is a current value at the current=the peak value.

An approximation expression of I-V characteristic due to only ohmic resistance and activation polarization upon current-increase as shown in FIG. 10 is set as follows:
V=a3I²+b3I+c3 (4).

Since a point at the current=0 A, that is, before a start of the discharge, the polarization is considered taking c1 as a criterion with respect to both the activation polarization and the concentration polarization, therefore c3=c1 from the expression (1). Further, supposing that the current rapidly increases from the initial state of current-increase, whereas the reaction of the concentration polarization is slow and does not make progress hardly, the derivation values of the expressions (1) and (4) at the current=0 A are the same, therefore b3=b1. Accordingly, by substituting c3=c1 and B3=b1, the expression (4) can be expressed as follows:
V=a3I2+b1I+c1. (5)
Therefore, an unknown quantity is only a3.

If a coordinate (Ip, V1) at the current peak value upon current-increase is substituted into the expression (5), the following expression is obtained:
a3=(V1−b1Ip−c1)/Ip².
Therefore, the approximation expression (4) of I-V characteristic due to only ohmic resistance and activation polarization is determined by the expression (5).

Generally, Since the ohmic resistance does not occur in response to a chemical reaction and remains unchanged if the SOC of the battery or temperature does not change, the ohmic resistance remains unchanged during one action of the starter motor. On the other hand, since the activation polarization resistance occurs in response to a chemical reaction when ions and electrons are transferred and since the activation polarization and concentration polarization affect each other, a curve of the activation polarization upon current-increase does not quite agree with a curve of the activation resistance upon current-decrease. Therefore, the expression (5) is considered to be a curve of the ohmic resistance and activation polarization upon current-increase, in which the concentration polarization component is removed.

In the following, a way how to remove the concentration polarization component from the curve upon current-decrease will be explained. A relation between the ohmic resistance and the activation polarization upon current-decrease can be obtained by a similar way as the deletion of the concentration polarization at the current peak value. Setting two points, i.e. A point and B point except the peak value point, the concentration polarization VpolcA and VpolcB at the respective points are computed as follows:
VpolcA=[(Asec from start of current-increase to A point)/(Asec for whole discharge)]×Vpolc0 (6)
VpolcB=[(Asec from start of current-increase to B point)/(Asec for whole discharge)]×Vpolc0 (7)

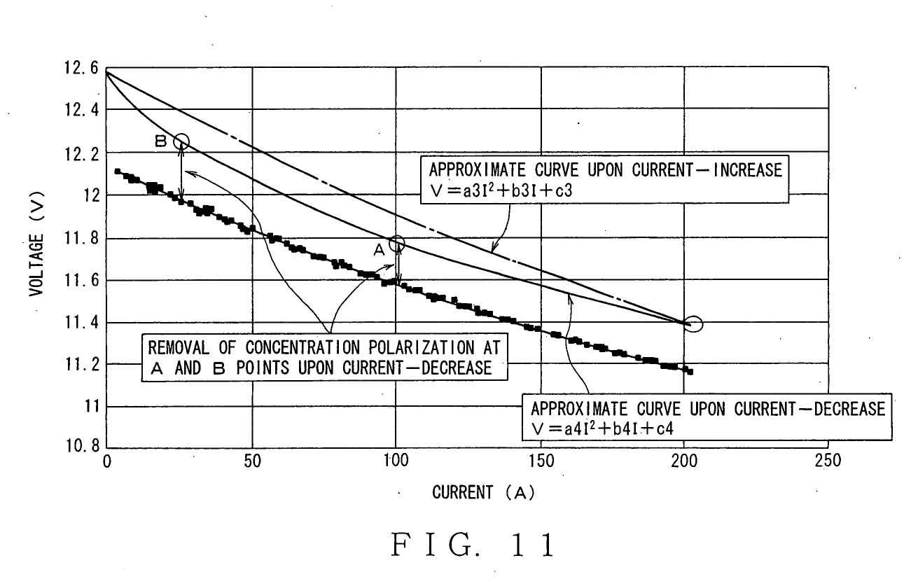

If the two points in which the concentration polarization component is removed are obtained except the peak value point from the expressions (6) and (7), by using coordinates of the three points, that is, the two points (i.e. A point and B point) and the peak value point, a curve of the ohmic resistance and the activation polarization upon current-decrease as shown in FIG. 11 is obtained, which is expressed by the following expression:
V=a4I²+b4I+c4 (8).
Here, the coefficients a4, b4 and c4 can be determined by solving simultaneous equations, which are obtained by substituting the respective current values and voltage values of the A point, B point and the peak value point into the expression (8).

In the following, a way how to compute the ohmic resistance of the battery will be explained. Since a difference between the curve (expressed by (5)) of the ohmic resistance and activation polarization upon current-increase, in which the concentration polarization component is removed, and a difference between the curve (expressed by (5)) of the ohmic resistance and activation polarization upon current-decrease, in which the concentration polarization component is removed, is due to a difference in the activation polarization component, therefore the ohmic resistance can be obtained by removing the activation polarization component.

Giving attention to the peak value of both curves, at which the respective values of the activation polarization become the same value, a derivative value R1 upon current-increase and a derivative value R2 upon current-decrease at the peak value are computed from the following expressions:
R1=2×a3×Ip+b3 (10)
R2=2×a4×Ip+b4 (11).

A difference between the derivative values R1 and R2 computed by the above expressions is due to a fact that one is the peak value of the activation polarization upon current-increase, whereas the other is peak value of the activation polarization upon current-decrease. When as a simulative discharge corresponding to a rush current, the battery is subjected to a discharge by using an electronic load, in which discharge the current increases from zero to 200 A in 0.25 seconds, then decreases from the peak value to zero in 0.25 seconds, since respective rates of change of both derivative values in the vicinity of the peak value are the same and it can be understood that there is a current—voltage characteristic due to the ohmic resistance in the middle of both derivative values, therefore the ohmic resistance R can be obtained by adding both derivative values and subsequently dividing the added value by 2 as the following expression (In this example, a value obtained by dividing both derivative values proportionally with respect to time ratio being equal to a value obtained by dividing the added value by 2):
R=(R1+R2)/2.

In the above description, an explanation is given for a case, in which the battery is subjected to a discharge by using an electronic load as a simulative discharge corresponding to a rush current. However, in a case of an actual vehicle, when a direct-current motor is used as a starter motor, the current reaches its peak value while a rush current flows into a field coil and the cranking is acting with a current, which decreases down to a current equal to or less than the peak current after reaching the peak current value.

Accordingly, a discharge upon current-increase is finished in a short period of time, that is, 3 millisecond (3 msec) and a change in the current is so rapid that the concentration polarization hardly occurs at the peak value upon current-increase. However, upon current-decrease, the current flows for a period of 150 msec that is very longer than the above time period (3 msec) upon current-increase, therefore a large concentration polarization occurs despite current-decrease. However, since during the cranking period a different phenomenon takes place compared to the time period when the rush current flows, therefore the discharge current and the terminal voltage of the battery during this cranking period should not be used as data for computing a current—voltage characteristic upon current-decrease.

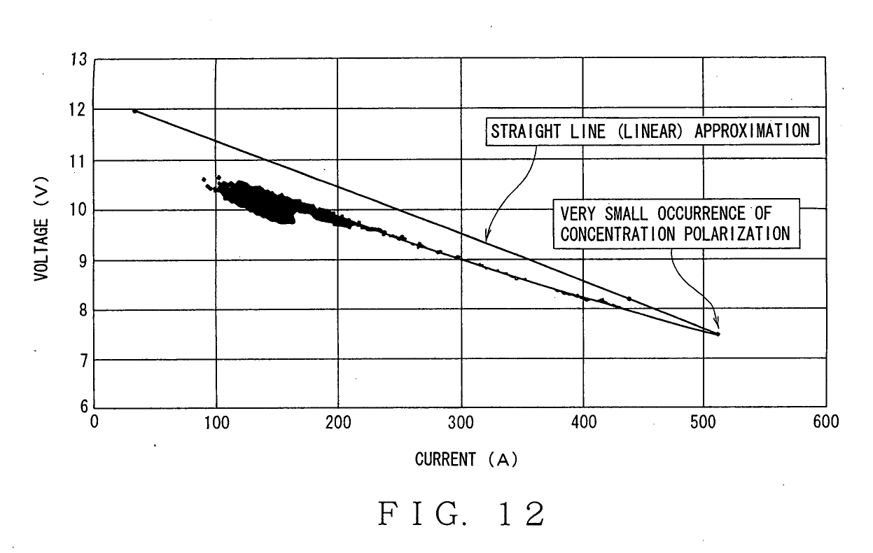

Under this situation, in an actual vehicle, as shown in FIG. 12, the I-V characteristic upon current-increase can be approximated by a straight line formed by connecting a point of start of current-increase and the point of the peak current value. Further, the occurrence of the concentration polarization at the peak value 500 A can be approximated as 0 A. In this case, regarding a discharge upon current-increase, a gradient of the approximate straight line upon current-increase is used as the derivative value at the peak current value.

However, in such a case described above, a gradient of the approximate straight line upon current-increase and a gradient of tangent line at the peak point in the quadratic approximate expression upon current-decrease cannot be simply averaged. Because in this situation, the degree of occurrence of the activation polarization before the current reaches the peak value is entirely different from that after the current reaches the peak, therefore a presupposition that both rates of change in the vicinity of the peak current value become the same is not materialized any more.

In such a case, when the ohmic resistance is computed, two values of variation in the terminal voltage per unit current change at the respective points corresponding to the peak values in first and second approximate expressions, in which the voltage drop due to the concentration polarization is removed, that is, two gradient values are multiplied by respective ratios of the time period of monotonous current increase and the time period of monotonous current decrease with respect to the total time period when the rush current flows, and thereafter the two multiplied values are added together. That is, the gradient values are multiplied by respective division ratios, which are obtained by proportionally dividing the total time period into the time period required for the monotonous current increase and the time period required for the monotonous current decrease, and thereafter thus obtained two values are added together. Thus, the ohmic resistance can be computed taking a fact that the activation polarization and the concentration polarization affect each other into consideration.

That is, although in principle the activation polarization occurs according to the current value, the activation polarization is affected by the concentration polarization in each situation and does not occur according to the principle. When the concentration polarization is small, the activation polarization is also small. When the concentration polarization is large, the activation polarization is also large. Anyway, a middle value of two variation values of the terminal voltage per unit current change at the respective points corresponding to the peak values in first and second approximate expressions, in which the voltage drop due to the concentration polarization is removed, can be measured as the value of the ohmic resistance of the battery.

As for a recent vehicle, an alternating motor, requiring three-phase input such as a DC brushless, such as a magnet motor has been frequently used as a motor. In such a case, the rush current does not reaches the peak current value in a very short period of time and takes 100 msec. Therefore, since the concentration polarization occurs during a discharge upon current-increase, the current variation curve upon current-increase should be approximated by a curve approximation.

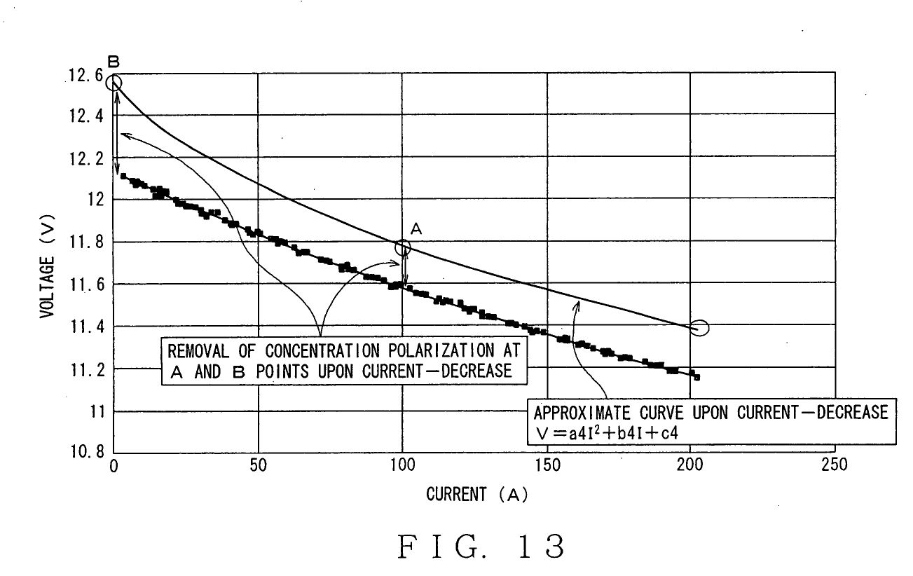

Further, when the ohmic resistance and the activation polarization upon current-decrease are to be approximated, when the peak value point and the other two points are to be determined, as shown in FIG. 13, a point of current=0 A is used as the B point, thereby simplifying a computation for obtaining the approximate expression.

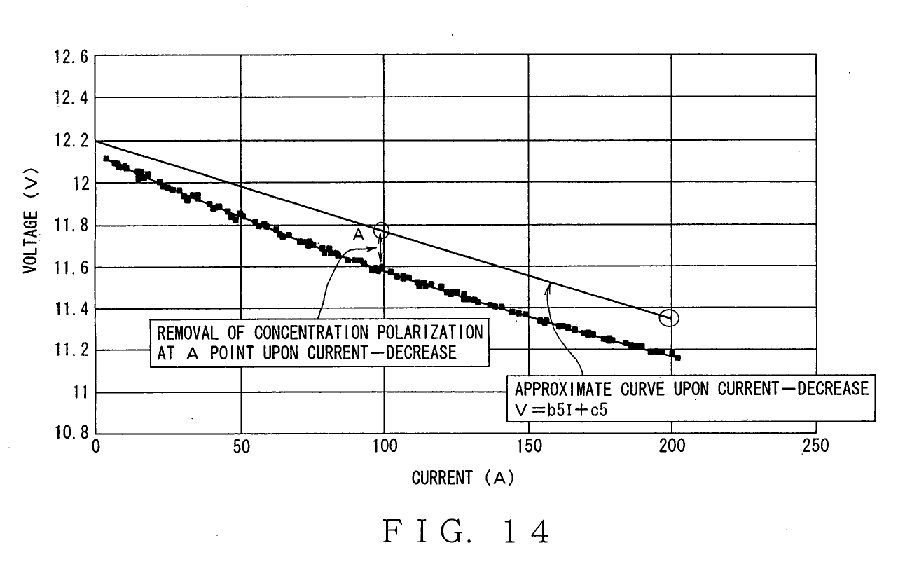

Further, when the point for removing the concentration polarization is determined to be a point corresponding to the current value of about half of the peak current, as shown in FIG. 14, the approximation may be done with a linear approximation to a straight line formed by connecting this point and the peak value point. In this case, as for a discharge upon current-increase, a gradient of the approximate straight line upon current-decrease is used as the derivative value of the peak value, thereby an accurate ohmic resistance can be obtained, which is almost the same as the value obtained by using the quadratic curve.

In short, a middle value of two variation values of the terminal voltage per unit current change at the respective points corresponding to the peak values in first and second approximate expressions, in which the voltage drop due to the concentration polarization is removed, can be measured as the value of the ohmic resistance of the battery.

In the following, a method of measuring an ohmic resistance of an on-vehicle battery will be explained in a case when a constant load, for example, a starter motor is used, wherein a rush current flows with the concentration polarization occurring in both cases of increase and decrease of the discharge current.

When the constant load acts, a discharge current flows, wherein the current monotonously increases exceeding a steady-value and monotonously decreases from a peak value to the steady-value. During that, the discharge current and the terminal voltage of the battery is periodically measured, for example, in a cycle of 100 microsecond (μsec), thereby obtaining a number of data pairs of the discharge current and the terminal voltage of the battery.

The latest pair of the discharge current and the terminal voltage of the battery thus obtained is stored and collected in a memory as rewritable storing means, for example, a RAM for a specific period of time. By using least squares method, from pairs of the discharge current and the terminal voltage of the battery thus stored and collected, as to the current—voltage characteristic for the increasing discharge current and the decreasing discharge current, which indicates a correlation between the discharge current and the terminal voltage, two curve approximate expressions as shown in the expressions (1) and (2) are obtained. Thereafter, the voltage drop due to the concentration polarization component is removed from the two approximate expressions, thereby obtaining revised curve approximate expressions that do not include the concentration polarization component.

For the purpose of this, a voltage difference between the voltage values in the expressions (1) and (2) at current=0 A (no. current flowing) is computed in such a manner that the voltage difference is due to only a voltage drop due to the concentration polarization. By using this voltage difference, a voltage drop due to the concentration polarization component at the current peak value on the approximate expression (1) of the I-V characteristic for the increasing discharge current is computed. For the purpose of this, a fact that the concentration polarization changes with the multiplication of the current by the time period, which is obtained by multiplying the magnitude of the current by a time period when the current flows, is used.

After the voltage drop due to the concentration polarization component at the current peak value on the approximate expression of the I-V characteristic for the increasing discharge current is computed, then the respective constants and the linear coefficients are put the same for the approximate expression excluding the concentration polarization therefrom and the approximate expression including the concentration polarization, thereby determining the quadratic coefficient of the approximate expression excluding the concentration polarization therefrom, so that the revised curve approximate expression (5) revised from the approximate expression of the I-V characteristic for the increasing discharge current is computed.

Thereafter, as for an I-V characteristic for a decreasing discharge current, an approximate expression that does not include the concentration polarization component is computed from the approximate expression (2). For the purpose of this, two points from each of which the concentration polarization component is removed are determined besides a point of the peak current value. At that time, it is taken into consideration that the concentration polarization component varies with the product of current and time period, which product is obtained by multiplying the magnitude of the current by the time period. If the two points from each of which the concentration polarization component is removed are determined, a revised approximate expression (8) revised from the approximate expression (2) as to the I-V characteristic for the decreasing discharge current is computed by using three coordinates consisting of the coordinates of the two points and the peak value point.

Since a difference between the revised curve approximate expression of the ohmic resistance and the activation polarization from which the concentration polarization component is removed upon current-increase expressed by the expression (5) and the revised curve approximate expression of the ohmic resistance and the activation polarization from which the concentration polarization component is removed upon current-decrease expressed by the expression (8) is due to a difference in the respective activation polarization component, therefore the ohmic resistance can be obtained if the activation polarization component is removed. That is, giving attention to the peak value of both approximate expressions, the difference between the derivative value upon current-increase and the derivative value upon current-decrease at the peak current value is due to that one is the value upon activation polarization-increase and the another is the value upon activation polarization-decrease, therefore supposing that an I-V characteristic due to the ohmic resistance exists in the middle of both rates of change in the vicinity of the peak current value, first both derivative values are multiplied by the respective ratios of the time period of monotonous current increase and the time period of monotonous current decrease to the total time period when the rush current flows, then thus multiplied respective derivative values are added to each other, thereby obtaining the ohmic resistance.

For example, if the time period of current increase and decrease are 3 msec and 100 msec, respectively, and the derivative values upon current-increase and current-decrease at the peak current value are Rpolk1 and Rpolk2, the ohmic resistance Rn can be computed as follows:
Rn=Rpolk1×100/103+Rpolk2×3/103.

The ohmic resistance Rn is computed and updated whenever a high-efficiency discharge in which a rush current occurs is carried out, for example whenever a starter motor is started to drive.

As an open circuit voltage of the battery for a vehicle in its equilibrium state, used is a terminal voltage of the battery measured when the battery is in its equilibrium state, in which the influence of the polarization occurred in the battery due to the former charge or discharge disappears so that a drop or increase in the terminal voltage of the battery due to the polarization disappears or, alternatively, a terminal voltage of the battery estimated from a result obtained by observing a change in the terminal voltage of the battery for a short period of time just after a charge or discharge is halted.

In the following, a method of detecting the saturated polarization of the battery and a method of detecting the dischargeable capacity according to the present invention will be explained.

The energy that the battery can actually supplies to the load is a capacity obtained by subtracting a capacity corresponding to the voltage drop component occurred inside the battery upon discharge, that is, a capacity that cannot be discharged due to the internal resistance of the battery from a charged capacity (i.e. product of current and time period) corresponding a value of the open circuit voltage of the battery.

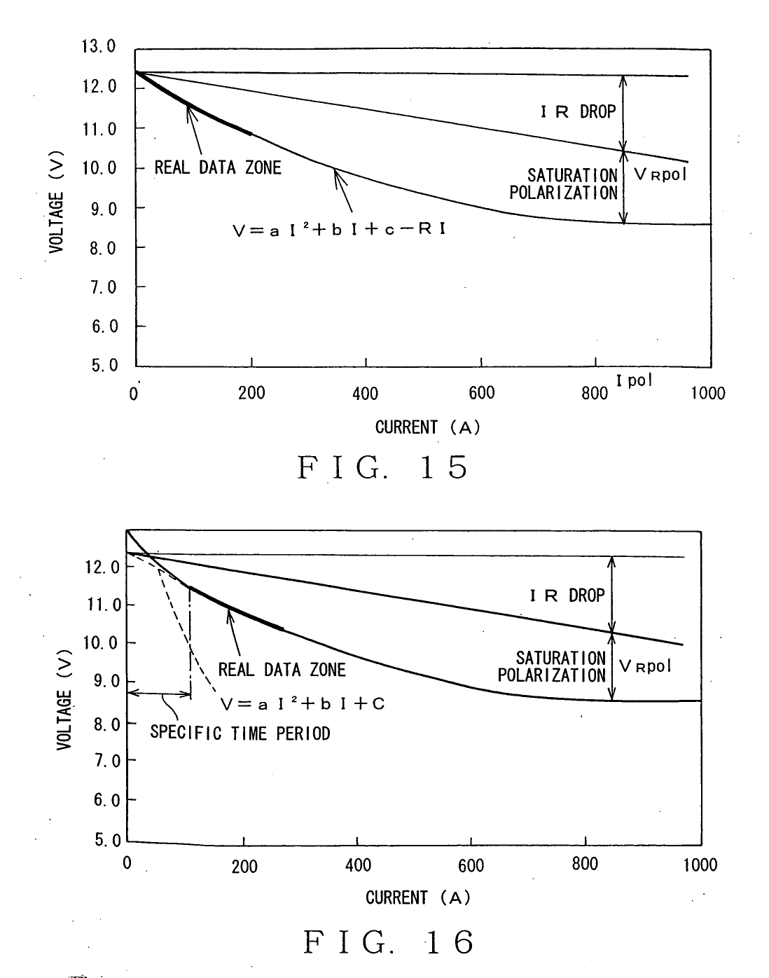

As shown in FIG. 15, a voltage drop occurred inside the battery during a discharge can be divided into a voltage drop component due to the ohmic resistance component of the battery (expressed by IR drop in FIG. 15) and a voltage drop component due to the internal resistance component except the ohmic resistance component, that is, the voltage drop component due to the polarization (expressed by saturation polarization in FIG. 15).

The IR drop described above does not vary if a state of the battery is the same. On the other hand, the voltage drop due to the polarization increases in proportion with the discharge current and discharge period of time, however it never increases exceeding the saturation polarization. Accordingly, if a point at which the voltage drop due to the polarization reaches the saturation polarization is monitored, a point at which the voltage drop due to the polarization reaches its maximum value can be monitored.

First, when the battery in an equilibrium state is subjected to a discharge or, alternatively, when the battery in a state that the terminal voltage upon a start of a discharge is lower than an open circuit voltage OVC0 upon the start of the discharge, that is, in a state that a discharge polarization remains is subjected to a discharge, as shown by a thick curve in FIG. 15, an approximate expression of the terminal voltage V with respect to the discharge current I expressed in the expression (12) described below is computed from the discharge current and the terminal voltage of the battery periodically measured during the discharge for a specific period of time (about a time period in which the polarization behavior appears and the time period being not longer than about 1 second) from the start of the discharge.

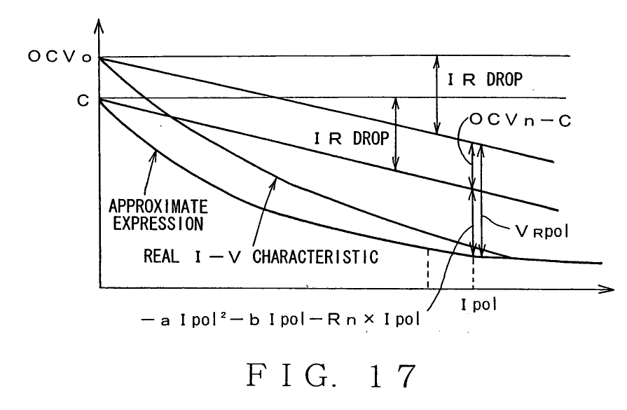

On the other hand, when the battery in a state that the terminal voltage upon a start of a discharge is higher than an open circuit voltage OVC0 upon the start of the discharge, that is, in a state that a charge polarization remains is subjected to a discharge, as shown by a thick curve in FIG. 16, an approximate expression of the terminal voltage V with respect to the discharge current I expressed in the expression (12) described below is computed from the discharge current and the terminal voltage of the battery periodically measured during the discharge when a specific period of time has passed from the start of the discharge so that the charge polarization is almost canceled. This is because that the approximate expression obtained from the discharge current and the terminal voltage of the battery detected in a period of time when the charge polarization remains has a poor correlation with an I-V characteristic that might be actually obtained from a discharge process, which is started from an equilibrium state of the battery.
V=aI²+bI+c (12)

The terminal voltage V of the battery described above is also expressed by the following expression (13) with a sum of the voltage drop component due to the ohmic resistance Rn component of the battery and the voltage drop component V_{R} due to the internal resistance component (i.e. voltage drop due to the polarization) except the ohmic resistance component:
V=c−(Rn×I+V_{R}) (13).

From the expressions (12) and (13), an expression as described below, the voltage drop due to the ohmic resistance, and the voltage drop due to the polarization can be obtained:
aI²+bI=−(Rn×I+V_{R}) (14).

By differentiating the expression (14), a rate of change dV_{R}/dI of the voltage drop due to the internal resistance component except the ohmic resistance component of the battery is obtained as follows:
dV_{R}/dI=−2aI−b−Rn (15).

A discharge current when the above rate of change dV_{R}/dI becomes zero corresponds to a saturation current value Ipol (=−(Rn+b)/2a) for terminal voltage drop when the voltage drop component due to the internal resistance component except the ohmic resistance component of the battery reaches its maximum value (i.e. saturated vale).

Then, if the discharge is a discharge from an equilibrium state, the obtained saturation current value Ipol for terminal voltage drop together with the ohmic resistance Rn value of the battery is substituted into the expression (14) as the discharge current I. Then, thus obtained voltage drop component V_{R} (=−aIpol²−bIpol−Rn×Ipol) due to the polarization is set to be the saturation polarization V_{R}pol.

On the other hand, if the discharge is a discharge from a state in which the charge polarization or discharge polarization remains, the obtained saturation current value Ipol for terminal voltage drop together with the ohmic resistance Rn value of the battery is substituted into the expression (14) as the discharge current I. Then, thus obtained voltage drop component V_{R} due to the polarization is added to a difference between the terminal voltage c when the discharge current is zero, which is obtained from the expression (12), and the open circuit voltage OVC0 upon the start of the discharge obtained from an estimation. A thus obtained value (=−aIpol²−bIpol−Rn×Ipol+(OCV0−c)) is set to be the saturation polarization V_{R}pol.

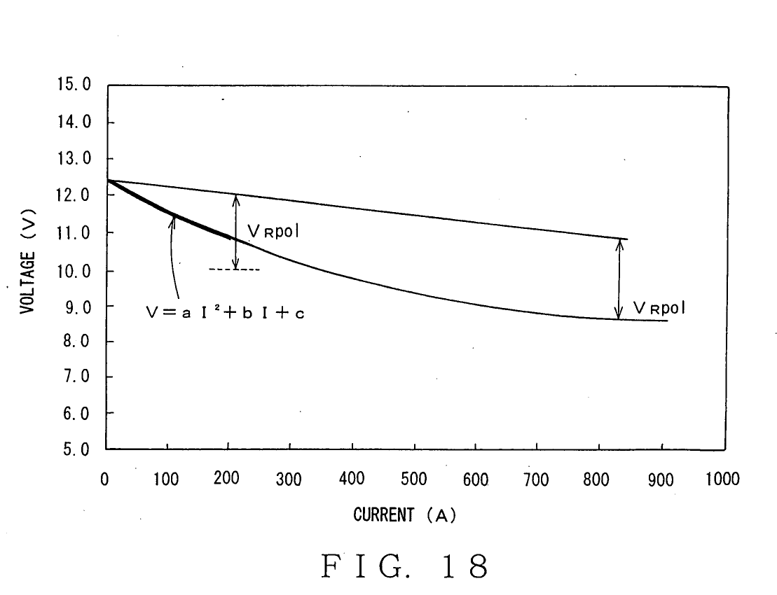

A reason why (OVC0−c) described above is added will be explained below. If the terminal voltage c when the discharge current is zero is computed from the approximate expression (12) on the basis of the discharge current and the terminal voltage actually measured for the specific period of time described above from a state in which the charge polarization or discharge polarization remains, the computed terminal voltage c is shown in FIG. 17. As shown in FIG. 17, the saturated value of the voltage drop obtained from the approximate expression is equal to the saturated value of the voltage drop in the I-V characteristic, which is actually obtained.

In this connection, even if the discharge is a discharge from a state in which the charge polarization remains, by setting a period of time after the specific time period from the discharge as the specific period of time, the computed terminal voltage c when the discharge current is zero, which is shown by the approximate expression, is lower than the open circuit voltage OVC0 upon the start of the discharge, At that time, as shown in FIG. 17, voltage drop component V_{R} (=−aIpol²−bIpol−Rn×Ipol) due to the polarization obtained by substituting Ipol into the expression (14) is a value obtained by subtracting the voltage drop component Rn×Ipol due to the ohmic resistance from the voltage drop having the terminal voltage c as a reference. Accordingly, in order to compute the saturation polarization V_{R}pol, which is a value obtained by subtracting the voltage drop component Rn×Ipol due to the ohmic resistance from the voltage drop of the battery, from the open circuit voltage OVC0, it is necessary to add (OVC0−c) to the voltage drop V_{R} (=−aIpol²−bIpol−Rn×Ipol) described above. The saturation polarization V_{R}Pol is computed and updated whenever the battery is subjected to a discharge.

If the saturation polarization V_{R}pol is computed as described above, by using the saturation polarization V_{R}pol, the detection of the rechargeable capacity as will be explained below is carried out, for example, whenever the battery is subjected to a discharge, said discharge having such a magnitude that a new detection of the dischargeable capacity is needed.

First, when a discharge is carried out, upon the discharge, the saturation polarization V_{R}pol is computed and the following expression is solved:
V_{ADC}=OCV0−Rn×Ip−V_{R}pol (16).
Here, V_{ADC} is a voltage value that indicates a present dischargeable capacity and Ip is the peak current value of the discharge.

That is, to solve the above expression is to compute the voltage value V_{ADC} corresponding to the present dischargeable capacity by subtracting the voltage drop component corresponding to the value of the ohmic resistance Rn of the battery and the saturation polarization V_{R}Pol from the open circuit voltage OVC0 upon the start of the discharge.

Then, the dischargeable capacity ADC is computed from the voltage value V_{ADC} that indicates the present dischargeable capacity by the conversion expression:
ADC=SOC×[(V_{ADC}−Ve)/(Vf−Ve)]×100(%),
wherein
SOC=[(OCVₙ−Ve)/(Vf−Ve)]×100(%).
Here, Vf is a voltage upon fully charged state and Ve is a voltage upon completion of the discharge.

Here, as shown in FIG. 19, the voltage Vf upon fully charged state of the battery can be obtained by subtracting the voltage drop corresponding to a value of the ohmic resistance Rnf0 of a new battery upon its fully charged state (state of charge: SOC=100%) from the open circuit voltage OCVf of the new battery upon its fully charged state (SOC=100%) as follows:
Vf=OCVf−Rnf0×Ip.

The voltage Ve upon completion of the discharge of the battery can be obtained by subtracting the voltage drop corresponding to a value of the ohmic resistance Rne0 of a new battery upon its completion of the discharge (state of charge: SOC=0%) from the open circuit voltage OCVe of the new battery upon its completion of the discharge (SOC=0%) as follows:
Ve=OCVe−Rne0×Ip.

The dischargeable capacity ADC may be computed from the voltage value V_{ADC} that indicates the present dischargeable capacity by the conversion expression shown below:
ADC=SOC×[(V_{ADC}−OCVe)/(OVC0−Rne0×Ip−OCVe)]×100(%).

The voltage drop component corresponding to the ohmic resistance Rn of the battery, which is to be subtracted from the open circuit voltage OCVn of the battery upon the start of the discharge, reflects a difference between the characteristics of the individual batteries. The present saturation polarization V_{R}pol of the battery reflects a difference in a degree of decrease in the dischargeable capacity due to that the discharge current has kept flowing and/or a difference in a degree of decrease in the dischargeable capacity due to a change in the internal resistance of the battery caused by a change in temperature.

Therefore, the dischargeable capacity ADC thus obtained as described above when the discharge is carried out is a correct dischargeable capacity, in which the influence of a difference between the characteristics of the individual batteries or the influence of a difference in a degree of decrease in the dischargeable capacity due to that the discharge current has kept flowing and/or a difference in a degree of decrease in the dischargeable capacity due to a change in the internal resistance of the battery caused by a change in temperature does not exist as an error.

As described above, it is possible to estimate the voltage drop component due to the internal resistance at the peak current value during the discharge, that is, it is possible to estimate the voltage drop due to the internal resistance at a time point when the voltage drop due to the ohmic resistance that is the component of the internal resistance except the polarization in the discharge process becomes its maximum.

Summarizing the measuring methods described above, in response to a discharge of the battery, the internal resistance monitoring means monitors the voltage drop due to the internal resistance of the battery when the voltage drop component of the terminal voltage due to the polarization occurred during the discharge is saturated. Therefore, it is possible to estimate the voltage drop due to the internal resistance at a time point when the voltage drop due to the polarization becomes the maximum value.

Further, in response to a discharge of the battery, the dischargeable capacity monitoring means detects a dischargeable capacity according to a value obtained by subtracting the voltage drop component due to the internal resistance of the battery when the voltage drop component of the terminal voltage due to the polarization occurred during the discharge is saturated from an open circuit voltage that corresponds to the state of charge (SOC) of the battery. Accordingly, it is possible to estimate the dischargeable capacity at a time point when the voltage drop due to the polarization becomes the maximum value.

Further, the internal resistance monitoring means monitors the voltage drop component obtained by adding the voltage drop component due to the pure resistance of the battery when the peak current flows during the discharge to the saturated value of the voltage drop component of the terminal voltage due to the polarization. Accordingly, in the discharge process, the voltage drop due to the internal resistance at a time point when the voltage drop due to the pure resistance of the battery, which is a component of the internal resistance except the polarization, becomes the maximum can be estimated.

Further, the dischargeable capacity monitoring means monitors a dischargeable capacity computed on the basis of a value, which is obtained by subtracting the voltage drop due to the pure resistance of the battery when the peak current value flows during the discharge and the saturated value of the voltage drop component of the terminal voltage due to the polarization from an open circuit voltage that corresponds to SOC of the battery. Accordingly, it is possible to estimate the dischargeable capacity at a time point when the voltage drop due to the pure resistance that is the component of the internal resistance except the polarization in the discharge process becomes its maximum.

When the battery is subjected to a discharge, an approximate expression of the terminal voltage with respect to the discharge current is obtained from the discharge current and the terminal voltage of the battery detected for a specific period of time of the discharge. The saturated polarization is detected on the basis of thus obtained approximate expression and the pure resistance of the battery. That is, the saturated polarization can be detected on the basis of the approximate expression computed from the discharge current and the terminal voltage detected in a specific period of time of the actual discharge and the pure resistance that is measured or estimated.

A relational expression among the approximate expression, the voltage drop component due to the pure resistance and the voltage drop component due to the polarization is differentiated by the discharge current, thereby computing an expression of a rate of change of the voltage drop component due to the polarization with respect to the discharge current. Thereafter, from the expression of the rate of change, a value of the discharge current at a time point when the rate of change becomes zero is computed as the terminal voltage drop saturated current value of the battery. Then, the voltage drop component due to the polarization obtained by substituting thus computed terminal voltage drop saturated current value into the relational expression described above is detected as the saturation polarization. Accordingly, the saturated polarization can be computed with giving attention to that the voltage drop component due to the polarization reaches the maximum value, i.e. the saturated value at a time point when the rate of change of the voltage drop with respect to the discharge current becomes zero.

If the terminal voltage when the discharge current becomes zero, which is computed from the approximate expression, is lower than the open circuit voltage upon the start of the discharge, a relational expression among the approximate expression, the voltage drop component due to the pure resistance and the voltage drop component due to the polarization is differentiated by the discharge current, thereby computing an expression of a rate of change of the voltage drop component due to the polarization with respect to the discharge current. Thereafter, from the expression of the rate of change, a value of the discharge current at a time point when the rate of change becomes zero is computed as the terminal voltage drop saturated current value of the battery. Then, a value obtained by adding a difference between the terminal voltage when the discharge current is zero computed from the approximate expression and the open circuit voltage upon the start of the discharge, to the voltage drop component due to the polarization obtained by substituting thus computed terminal voltage drop saturated current value into the relational expression described above, is detected as the saturation polarization.

Accordingly, the saturated polarization can be computed with giving attention to that the voltage drop component due to the polarization reaches the maximum value, i.e. the saturated value at a time point when the rate of change of the voltage drop with respect to the discharge current becomes zero. Further, by adding a difference between the terminal voltage when the discharge current is zero computed from the approximate expression and the open circuit voltage upon the start of the discharge, the saturation polarization is accurately computed even if the battery is not in an equilibrium state upon the start of the discharge.

The relational expression described above is an expression, in which the terminal voltage expressed by the approximate expression is expressed by the voltage drop component due to the pure resistance and the voltage drop component due to the polarization. Accordingly, the saturation polarization can be computed from the simple relational expression.

The approximate expression of the terminal voltage with respect to the discharge current, which is computed from the discharge current and the terminal voltage of the battery detected for a time period when the charge polarization occurs, has a poor correlation with a discharge current-terminal voltage characteristic that might be actually obtained from a discharge process, which is started from an equilibrium state of the battery. Therefore, as for the discharge of the battery in which the charge polarization occurs, an approximate expression of the terminal voltage with respect to the discharge current is computed from the discharge current and the terminal voltage of the battery detected for such a specific time period that the charge polarization is almost canceled after a specific period of time has passed after the start of the discharge. That is, the approximate expression of the terminal voltage with respect to the discharge current is computed from the discharge current and the terminal voltage of the battery detected for such a specific time period that the charge polarization is almost canceled, thereby an accurate discharge polarization can be computed.

The internal resistance monitoring means monitors the voltage drop component due to the internal resistance of the battery computed on the basis of the saturation polarization detected by using the method of detecting the saturation polarization described above. Therefore, it is possible to more accurately detect the voltage drop due to the internal resistance at a time point when the voltage drop due to the polarization is saturated.

A voltage value, which is obtained by subtracting the voltage drop component corresponding to the pure resistance upon the start of the discharge of the battery and the saturation polarization detected by using the method of detecting the saturation polarization described above from the open circuit voltage of the battery upon the start of the discharge, is a voltage value that corresponds to a dischargeable capacity when the polarization of the battery is saturated.

The voltage drop component corresponding to the pure resistance of the battery, which is to be subtracted from the open circuit voltage of the battery upon the start of the discharge, reflects a difference between the characteristics of the individual batteries. The saturation polarization of the battery detected by using the method of detecting the saturation polarization described above reflects a difference in a degree of decrease in the dischargeable capacity due to that the discharge current has kept flowing and/or a difference in a degree of decrease in the dischargeable capacity due to a change in the internal resistance of the battery caused by a change in temperature.

Therefore, the dischargeable capacity thus obtained as described above when the discharge is carried out is a correct dischargeable capacity, in which the influence of a difference between the characteristics of the individual batteries or the influence of a difference in a degree of decrease in the dischargeable capacity due to that the discharge current has kept flowing and/or a difference in a degree of decrease in the dischargeable capacity due to a change in the internal resistance of the battery caused by a change in temperature does not exist as an error.

If the terminal voltage when the discharge current becomes zero, which is computed from the approximate expression, is lower than the open circuit voltage upon the start of the discharge, a voltage value, which is obtained by subtracting the voltage drop component corresponding to the pure resistance upon the start of the discharge of the battery, the saturation polarization detected by using the method of detecting the saturation polarization described above, and a difference between the terminal voltage when the discharge current is zero computed from the approximate expression and the open circuit voltage upon the start of the discharge from the open circuit voltage of the battery upon the start of the discharge, is a voltage value that corresponds to a dischargeable capacity when the polarization of the battery is saturated.

The voltage drop component corresponding to the pure resistance of the battery, which is to be subtracted from the open circuit voltage of the battery upon the start of the discharge, reflects a difference between the characteristics of the individual batteries. The saturation polarization of the battery detected by using the method of detecting the saturation polarization described above reflects a difference in a degree of decrease in the dischargeable capacity due to that the discharge current has kept flowing and/or a difference in a degree of decrease in the dischargeable capacity due to a change in the internal resistance of the battery caused by a change in temperature.

Therefore, the dischargeable capacity thus obtained as described above when the discharge is carried out is a correct dischargeable capacity, in which the influence of a difference between the characteristics of the individual batteries or the influence of a difference in a degree of decrease in the dischargeable capacity due to that the discharge current has kept flowing and/or a difference in a degree of decrease in the dischargeable capacity due to a change in the internal resistance of the battery caused by a change in temperature does not exist as an error. Further, by subtracting a difference between the terminal voltage when the discharge current is zero computed from the approximate expression and the open circuit voltage upon the start of the discharge, the saturation polarization is accurately computed even if the battery is not in an equilibrium state upon the start of the discharge.

Further, a dischargeable capacity is computed taking a change in the state of charge—open circuit voltage characteristic of the battery, which change occurs due to the deterioration of the battery, into consideration. Therefore, when the dischargeable capacity is to be computed on the basis of the terminal voltage of the battery such as the open circuit voltage and the voltage drop component due to the internal resistance of the battery, a change in the state of charge—open circuit voltage characteristic of the battery, which change occurs due to the deterioration of the battery, can be taken into consideration.

A first rate of change is a rate of change of the open circuit voltage of a new battery for a calculation, which corresponds to the state of charge that is decreased due to the discharge. A second rate of change is a rate of change of the estimated or measured open circuit voltage, which corresponds to the state of charge that is decreased due to the discharge.

A ratio of the first rate of change to the second rate of change changes when an ratio of an amount of the active material that performs the transfer of electric charges in the electrolyte of the battery to an amount of water changes compared to the ratio upon the new battery so that a ratio of a rate of change of the open circuit voltage to a rate of change of the state of charge becomes large.

Therefore, the dischargeable capacity is computed on the basis of the ratio of the first rate of change to the second rate of change and the subtracted value described above, thereby the dischargeable capacity is computed taking inactivation for the active material of the battery into consideration.

The dischargeable capacity detecting means detects the dischargeable capacity by using the method of detecting dischargeable capacity described above. Accordingly, it is possible to more accurately detect the dischargeable capacity at a time point when the voltage drop due to the polarization is saturated.

In this connection, a change in the conversion expression for computing the dischargeable capacity ADC from the voltage value V_{ADC} that indicates the present dischargeable capacity for responding to a change in the ratio of an amount of the active material to an amount of water may be omitted.

In the explanation described above, when the saturation polarization is computed upon the discharge from a state in which the charge polarization or discharge polarization remains, the saturation polarization is set to be a value obtained by adding (OVC0−c) to the voltage drop V_{R} (=−aIpol²−bIpol−Rn×Ipol) due to the polarization, which is obtained by substituting Ipol into the expression (14). However, instead, for example, the voltage drop V_{R} (=−aIpol²−bIpol−Rn×Ipol) due to the polarization, which is obtained by substituting Ipol into the expression (14), may be set to be the saturation polarization even if the polarization remains upon the start of the discharge or even if the battery has not been in an equilibrium state upon the start of the discharge, so that thereafter (OVC0−c) is subtracted from the open circuit voltage OVC0 at a time point when the voltage V_{ADC} is calculated.

The microcomputer 23 performs the detection of various quantities during the discharge of the battery on the basis of the outputs from the current sensor 15 and the voltage sensor 17, thereby the voltage drop due to the internal resistance of the battery 13 when the polarization of the battery 13 is saturated and the dischargeable capacity ADC of the battery 13 are detected and monitored. That is, the microcomputer 23 functions as the internal resistance monitoring means and the dischargeable capacity monitoring means.

Since the voltage drop due to the internal resistance at a time point when the voltage drop due to the polarization becomes the maximum value and the dischargeable capacity can be estimated, therefore a state of the battery can be accurately estimated.

The aforementioned preferred embodiments are described to aid in understanding the present invention and variations or applications may be made by one skilled in the art without departing from the spirit and scope of the present invention.

For example, in the preferred embodiments described above, the state of charge (SOC) is expressed by using a percent (%) value as its unit, which percent value is a ratio of the capacity upon a given state of the battery to the capacity upon the fully charged state of the battery. However, instead, ampere·hour (Ah), by which an electric quantity is expressed by an absolute magnitude, may be used as the unit.

### INDUSTRIAL APPLICABILITY

As explained hereinbefore, according to the present invention defined in claim 1, the deterioration state of the battery can be appropriately judged with respect to the predetermined minimum guaranteed voltage.

According to the present invention defined in claim 2, the deterioration of the battery can be timely judged with respect to the predetermined minimum guaranteed voltage.

According to the present invention defined in claim 3, the deterioration of the battery can be accurately judged with respect to the predetermined minimum guaranteed voltage even in a low state of charge, in which a terminal voltage might be lower than the minimum guaranteed voltage even for a normal battery.

According to the present invention defined in claim 4, the deterioration of the battery can be appropriately judged with respect to the predetermined minimum guaranteed dischargeable capacity.

According to the present invention defined in claim 5, the deterioration of the battery can be timely judged with respect to the predetermined minimum guaranteed dischargeable capacity.

According to the present invention defined in claim 6, the deterioration of the battery can be accurately judged with respect to the predetermined minimum guaranteed dischargeable capacity even in a low state of charge, in which a terminal voltage might be lower than the minimum guaranteed voltage even for a normal battery.

According to the present invention defined in claim 7, the deterioration of the battery can be appropriately judged with respect to the predetermined minimum guaranteed dischargeable capacity taking the error in detecting the dischargeable capacity into consideration as well.

According to the present invention defined in claim 8, the deterioration of the battery can be timely judged with respect to the predetermined minimum guaranteed dischargeable capacity taking the error in detecting the dischargeable capacity into consideration as well.

According to the present invention defined in claim 9, the deterioration of the battery can be accurately judged with respect to the predetermined minimum guaranteed dischargeable capacity taking the error in detecting the dischargeable capacity into consideration as well even in a low state of charge, in which a terminal voltage might be lower than the minimum guaranteed voltage even for a normal battery.

According to the present invention defined in claim 10, when electric power is supplied from the battery to a load in a system, which must be controlled so as not to be in a low state of charge, as for a battery that has been at least once undergone a state of charge lower than the second specific value for a reason that, for example, the battery has been left for a time period longer than a guaranteed time period, the deterioration of the battery can be accurately judged so as to guarantee high reliability in the system.

According to the present invention defined in claim 11, a user of the battery can be timely aware of the deterioration of the battery so as to replace the battery with a non-deteriorated battery.

According to the present invention defined in claim 12, the deterioration of the battery can be timely judged with respect to the predetermined minimum guaranteed voltage.

According to the present invention defined in claim 13, the deterioration of the battery can be accurately judged with respect to the predetermined minimum guaranteed voltage even in a low state of charge, in which a terminal voltage might be lower than the minimum guaranteed voltage even for a normal battery.

According to the present invention defined in claim 14, the deterioration of the battery can be timely judged with respect to the predetermined minimum guaranteed dischargeable capacity.

According to the present invention defined in claim 15, the deterioration of the battery can be accurately judged with respect to the predetermined minimum guaranteed dischargeable capacity even in a low state of charge, in which a terminal voltage might be lower than the minimum guaranteed voltage even for a normal battery.

According to the present invention defined in claim 16, the deterioration of the battery can be timely judged with respect to the predetermined minimum guaranteed dischargeable capacity taking the error in detecting the dischargeable capacity into consideration as well.

According to the present invention defined in claim 17, the deterioration of the battery can be accurately judged with respect to the predetermined minimum guaranteed dischargeable capacity even in a low state of charge, in which a terminal voltage is lower than the minimum guaranteed voltage even for a normal battery taking the error in detecting the dischargeable capacity into consideration as well.

According to the present invention defined in claim 18, therefore when electric power is supplied from the battery to a load in a system, which must be controlled so as not to be in a low state of charge, as for a battery that has been at least once undergone a state of charge lower than the second specific value for a reason that, for example, the battery has been left for a time period longer than a guaranteed time period, the deterioration of the battery can be accurately judged so as to guarantee high reliability in the system.

According to the present invention defined in claim 19, a user of the battery can be timely aware of the deterioration of the battery so as to replace the battery with a non-deteriorated battery.

1. A method of judging deterioration of a battery that supplies electric power to a load comprising the steps of:
comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
judging the deterioration of the battery on the basis of a result of the comparison.

2. A method of judging deterioration of a battery that supplies electric power to a load comprising the steps of:
comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
judging that the battery is deteriorated if the first difference value becomes equal to or smaller than the minimum guaranteed voltage and the state of charge upon the start of the discharge exceeds a first specific value.

3. A method of judging deterioration of a battery that supplies electric power to a load comprising the steps of:
comparing a minimum guaranteed voltage predetermined as a minimum value of a terminal voltage of the battery when a given current flows into the load, with a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;
if the first difference value becomes equal to or smaller than the minimum guaranteed voltage and the state of charge upon the start of the discharge is equal to or smaller than a first specific value, converting the state of charge that is equal to or smaller than the first specific value into a state of charge of the first specific value;
comparing the minimum guaranteed voltage with a second difference value, which is obtained by subtracting the voltage drop from an open circuit voltage that corresponds to the converted state of charge of the first specific value; and
judging that the battery is deteriorated if the second difference value is equal to or smaller than the minimum guaranteed voltage.

4. A method of judging deterioration of a battery that supplies electric power to a load comprising the steps of:
comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
judging the deterioration of the battery on the basis of a result of the comparison.

5. A method of judging deterioration of a battery that supplies electric power to a load comprising the steps of:
comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
judging that the battery is deteriorated if the first estimated dischargeable capacity becomes equal to or smaller than the minimum guaranteed dischargeable capacity and the state of charge upon the start of the discharge exceeds a first specific value.

6. A method of judging deterioration of a battery that supplies electric power to a load comprising the steps of:
comparing a minimum guaranteed dischargeable capacity predetermined for supplying an electrical quantity required at the minimum to the load for a specific period of time when a given current flows into the load, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;
if the first estimated dischargeable capacity becomes equal to or smaller than the minimum guaranteed dischargeable capacity and the state of charge upon the start of the discharge is equal to or smaller than a first specific value, converting the state of charge that is equal to or smaller than the first specific value into a state of charge of the first specific value;
comparing the minimum guaranteed dischargeable capacity with a second estimated dischargeable capacity, which is estimated for the converted state of charge of the first specific value; and
judging that the battery is deteriorated if the second estimated dischargeable capacity is equal to or smaller than the minimum guaranteed dischargeable capacity.

7. A method of judging deterioration of a battery that supplies electric power to a load comprising the steps of:
comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
judging the deterioration of the battery on the basis of a result of the comparison.

8. A method of judging deterioration of a battery that supplies electric power to a load comprising the steps of:
comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
judging that the battery is deteriorated if the first estimated dischargeable capacity becomes equal to or smaller than the summed value and the state of charge upon the start of the discharge exceeds a first specific value.

9. A method of judging deterioration of a battery that supplies electric power to a load comprising the steps of:
comparing a summed value of (a) a minimum guaranteed dischargeable capacity predetermined for supplying an electrical quantity required at the minimum to the load for a specific period of time when a given current flows into the load and (b) an error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;
if the first estimated dischargeable capacity becomes equal to or smaller than the summed value and the state of charge upon the start of the discharge is equal to or smaller than a first specific value, converting the state of charge that is equal to or smaller than the first specific value into a state of charge of the first specific value;
comparing the minimum guaranteed dischargeable capacity with a second estimated dischargeable capacity, which is estimated for the converted state of charge of the first specific value; and
judging that the battery is deteriorated if the second estimated dischargeable capacity is equal to or smaller than the summed value.

10. A method of judging deterioration of a battery as claimed in claim 1, wherein the battery is judged deteriorated if the state of charge of the battery becomes equal to or smaller than a second specific value that is set lower than the first specific value.

11. A method of judging deterioration of a battery according to claim 2, wherein when the battery is judged deteriorated, a display for warning deterioration of the battery is carried out.

12. An apparatus for judging deterioration of a battery that supplies electric power to a load comprising:
storing means for storing a minimum guaranteed voltage predetermined as a minimum value of a terminal voltage of the battery when a given current flows into the load;
voltage drop computing means for computing a voltage drop due to an ohmic resistance and polarization resistance of the battery occurred in response to a discharge of the battery when a given current flows from the battery into the load;
first comparing means for comparing the minimum guaranteed voltage stored in the storing means with a first difference value, which is obtained by subtracting the voltage drop computed by the voltage drop computing means from an open circuit voltage that corresponds to a state of charge upon a start of the discharge of the battery; and
first deterioration judging means for judging that the battery is deteriorated if the first difference value becomes equal to or smaller than the minimum guaranteed voltage and the state of charge upon the start of the discharge exceeds a first specific value as a result of the comparison by the first comparing means.

13. An apparatus for judging deterioration of a battery that supplies electric power to a load comprising:
storing means for storing a minimum guaranteed voltage predetermined as a minimum value of a terminal voltage of the battery when a given current flows into the load;
voltage drop computing means for computing a voltage drop due to an ohmic resistance and polarization resistance of the battery occurred in response to a discharge of the battery when a given current flows from the battery into the load;
first comparing means for comparing the minimum guaranteed voltage stored in the storing means with a first difference value, which is obtained by subtracting the voltage drop computed by the voltage drop computing means from an open circuit voltage that corresponds to a state of charge upon a start of the discharge of the battery;
conversion means for converting a state of charge that is equal to or smaller than the first specific value into a state of charge of the first specific value, if the first difference value becomes equal to or smaller than the minimum guaranteed voltage and the state of charge upon the start of the discharge is equal to or smaller than a first specific value as a result of the comparison by the first comparing means;
second comparing means for comparing the minimum guaranteed voltage with a second difference value, which is obtained by subtracting the voltage drop from an open circuit voltage that corresponds to the state of charge of the first specific value converted by the conversion means; and
first deterioration judging means for judging that the battery is deteriorated if the second difference value is equal to or smaller than the minimum guaranteed voltage.

14. An apparatus for judging deterioration of a battery that supplies electric power to a load comprising:
storing means for storing a minimum guaranteed dischargeable capacity predetermined for supplying an electrical quantity required at the minimum to the load for a specific period of time when a given current flows into the load,
voltage drop computing means for computing a voltage drop due to an ohmic resistance and polarization resistance of the battery occurred in response to a discharge of the battery when a given current flows from the battery into the load;
third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
first deterioration judging means for judging that the battery is deteriorated if the first estimated dischargeable capacity becomes equal to or smaller than the minimum guaranteed dischargeable capacity and the state of charge upon the start of the discharge exceeds a first specific value as a result of the comparison by the third comparing means.

15. An apparatus for judging deterioration of a battery that supplies electric power to a load comprising:
storing means for storing a minimum guaranteed dischargeable capacity predetermined for supplying an electrical quantity required at the minimum to the load for a specific period of time when a given current flows into the load,
voltage drop computing means for computing a voltage drop due to an ohmic resistance and polarization resistance of the battery occurred in response to a discharge of the battery when a given current flows from the battery into the load;
third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;
conversion means for converting a state of charge that is equal to or smaller than the first specific value into a state of charge of the first specific value, if the first estimated dischargeable capacity becomes equal to or smaller than the minimum guaranteed dischargeable capacity and the state of charge upon the start of the discharge exceeds a first specific value as a result of the comparison by the third comparing means;
fourth comparing means for comparing the minimum guaranteed dischargeable capacity with a second estimated dischargeable capacity, which is estimated for the state of charge of the first specific value converted by the conversion means; and
first deterioration judging means for judging that the battery is deteriorated if the second estimated dischargeable capacity is equal to or smaller than the minimum guaranteed dischargeable capacity.

16. An apparatus for judging deterioration of a battery that supplies electric power to a load comprising:
storing means for storing (a) a minimum guaranteed dischargeable capacity predetermined for supplying an electrical quantity required at the minimum to the load for a specific period of time when a given current flows into the load and (b) an error in detecting the dischargeable capacity;
voltage drop computing means for computing a voltage drop due to an ohmic resistance and polarization resistance of the battery occurred in response to a discharge of the battery when a given current flows from the battery into the load;
third comparing means for comparing a summed value of (a) the minimum guaranteed dischargeable capacity stored in the storing means and (b) the error in detecting the dischargeable capacity, with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current; and
first deterioration judging means for judging that the battery is deteriorated if the first estimated dischargeable capacity becomes equal to or smaller than the summed value and the state of charge upon the start of the discharge exceeds a first specific value as a result of the comparison by the third comparing means.

17. An apparatus for judging deterioration of a battery that supplies electric power to a load comprising:
storing means for storing (a) a minimum guaranteed dischargeable capacity predetermined for supplying an electrical quantity required at the minimum to the load for a specific period of time when a given current flows into the load and (b) an error in detecting the dischargeable capacity;
voltage drop computing means for computing a voltage drop due to an ohmic resistance and polarization resistance of the battery occurred in response to a discharge of the battery when a given current flows from the battery into the load;
third comparing means for comparing the minimum guaranteed dischargeable capacity stored by the storing means with a first estimated dischargeable capacity estimated on the basis of a first difference value, which is obtained by subtracting a voltage drop due to an ohmic resistance and polarization resistance of the battery occurred during a discharge of the battery from an open circuit voltage that corresponds to a state of charge upon a start of the discharge of the battery in response to the discharge of the battery with the given current;
conversion means for converting a state of charge that is equal to or smaller than a first specific value into a state of charge of the first specific value, if the first estimated dischargeable capacity becomes equal to or smaller than a summed value of (a) the minimum guaranteed dischargeable capacity and (b) the error in detecting the dischargeable capacity stored in the storing means and the state of charge upon the start of the discharge is equal to or smaller than a first specific value as a result of the comparison by the third comparing means;
fourth comparing means for comparing the minimum guaranteed dischargeable capacity with a second estimated dischargeable capacity, which is estimated for the state of charge of the first specific value converted by the conversion means; and
first deterioration judging means for judging that the battery is deteriorated if the second estimated dischargeable capacity is equal to or smaller than the summed value.

18. An apparatus for judging deterioration of a battery according to claim 12, further comprising second deterioration judging means for judging that the battery is deteriorated if the state of charge of the battery becomes equal to or smaller than a second specific value that is set lower than the first specific value.

19. An apparatus for judging deterioration of a battery according to claim 12, further comprising warning display means for carrying out a display for warning deterioration of the battery when the battery is judged deteriorated.
